(19) United States
(12) Patent Application Publication
(10) Pub. No.: US 2024/0087175 A1
(43) Pub. Date: Mar. 14, 2024

(54) SPARSITY COMPRESSION FOR COMPUTER VISION, LANGUAGE MODEL AND AI APPLICATION

(71) Applicants: Joshua Huang, Cupertino, CA (US); Hsilin Huang, Cupertino, CA (US)

(72) Inventors: Joshua Huang, Cupertino, CA (US); Hsilin Huang, Cupertino, CA (US)

(21) Appl. No.: 18/507,915

(22) Filed: Nov. 13, 2023

Related U.S. Application Data
(63) Continuation-in-part of application No. 17/886,186, filed on Aug. 11, 2022.
Application No. 17/886,186 is a continuation-in-part of application No. 16/773,976, filed on Jan. 27, 2020, now Pat. No. 11,469,772.
Application No. 16/773,976 is a continuation-in-part of application No. 15/485,036, filed on Apr. 11, 2017, now Pat. No. 10,565,207.
(60) Provisional application No. 62/323,699, filed on Apr. 17, 2016.
(60) Provisional application No. 62/322,802, filed on Apr. 15, 2016.
(60) Provisional application No. 62/321,683, filed on Apr. 12, 2016.

(51) Int. Cl. G06T 9/00; G06N 3/0464; G06T 7/11; G06T 9/40

(52) U.S. Cl. CPC G06T 9/002; G06N 3/0464; G06T 7/11; G06T 9/40; G06T 2207/10028; G06T 2207/20021; G06T 2207/20081; G06T 2207/20084

(57) ABSTRACT

A method and apparatus for receiving an input data; configuring the input data into a multiple arrayed data block; configuring the multiple arrayed data block into a plurality of data sub-blocks; recording non-zero values of the data sub-blocks; arranging the data block into a first bit mask block; dividing the first bit mask block into sub-block mask(s); packing or compressing sub-block masks with non-zero cell contents, wherein sub-block masks with all-zero cell contents are not packed; assigning indices or location indicators to the packed sub-block masks; and storing the packed sub-block masks and corresponding indices or location indicators.

### CROSS-REFERENCE TO RELATED APPLICATIONS

The present continuation-in-part patent application claims priority benefit under 35 U.S.C. 120 of the U.S. nonprovisional patent application Ser. No. 17/886,186 entitled “SPARSITY COMPRESSION FOR POINT CLOUD AND VOXEL” filed on 8 Aug. 2022, which claims priority to U.S. nonprovisional patent application Ser. No. 16/773,976 entitled “A Method, System and Program Product for Mask-Based Compression of a Sparse Matrix” filed on 27 Jan. 2020, which claims priority to U.S. nonprovisional patent application Ser. No. 15/485,036 entitled “A Method, System and Program Product for Mask-Based Compression of a Sparse Matrix”, filed on 11 Apr. 2017, which further claims priority to U.S. provisional application for patent Ser. No. 62,321,683 entitled “MASKED BASED COMPRESSION SCHEME AND ZERO-SKIPPING OPERATION FOR ARTIFICIAL INTELLIGENCE”, filed on 12 Apr. 2016, provisional patent Ser. No. 62/322,802 entitled “A REVOLUTIONARY INSTRUCTION SEQUENCER OR CONTROLLER WITH MAS OPERATION AND ZERO-SKIPPING FOR ARTIFICIAL INTELLIGENCE”, filed on 15 Apr. 2016, and provisional patent Ser. No. 62/323,699 entitled “A REVOLUTIONARY MIMD PROCESSOR TH MAST OPERATION AND ZERO-SKIPPING NAD SIMD PROCESSOR FOR ARTIFICIAL INTELLIGENCE” filed on 17 Apr. 2016 under 35 U.S.C. 119(e). The contents of this/these related patent application(s) is/are incorporated herein by reference for all purposes to the extent that such subject matter is not inconsistent herewith or limiting hereof.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to machine learning systems. More particularly, certain embodiments of the invention relate to sparsity compression for point cloud, event-based pixels and voxel.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

A typical neural network may use input data and weight to classify an object. The weight and feature map typically may be large. In numerical analysis, a sparse matrix is a matrix in which most of the elements are zero. By contrast, if most of the elements are nonzero, then the matrix is considered dense. The number of zero-valued elements divided by the total number of elements is called the sparsity of the matrix. When storing and manipulating sparse matrices on a computer, it may be beneficial and often necessary to use specialized algorithms and data structures that take advantage of the sparse structure of the matrix. Operations using standard dense-matrix structures and algorithms are believed to be slow and inefficient when applied to large sparse matrices as processing and memory are wasted on the zeroes. Sparse data is by nature more easily compressed and thus require significantly less storage.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A is an illustration of an exemplary Point Cloud Coordinate System and FIG. 1B is an illustration of an exemplary Point Cloud Coordinate System Data, in accordance with an embodiment of the present invention;

FIG. 2A is an illustration of an exemplary image coordinate system and FIG. 2B is an illustration of an exemplary LiDAR coordinate system or point cloud coordinate system, in accordance with an embodiment of the present invention;

FIG. 3A and FIG. 3B is an illustration of an exemplary point cloud data and voxel data from open3d, in accordance with an embodiment of the present invention.

FIG. 4A and FIG. 4B is an illustration of an exemplary image-based camera output data and event-based camera output data, in accordance with an embodiment of the present invention;

FIG. 5 is an illustration of an exemplary sparse point cloud format, in accordance with an embodiment of the present invention;

FIG. 6A is an illustration of an exemplary multiple hierarchical layers to store sparse data format, FIG. 6B is an illustration of an exemplary multiple hierarchical layers to represent the location and value, and FIG. 6C is an illustration of an exemplary 4×4 second level mask table, in accordance with an embodiment of the present invention;

FIG. 7 is an illustration of an exemplary CSR (compress sparse row) format, in accordance with an embodiment of the present invention;

FIG. 8 is an illustration of an exemplary multiple hierarchical layers with CSR (compress sparse row) 800 to represent the location and value, in accordance with an embodiment of the present invention;

FIG. 9 is an illustration of an exemplary multiple hierarchical method to represent, point cloud, voxel and/or event-based pixels, in accordance with an embodiment of the present invention;

FIG. 10 is an illustration of an exemplary multiple hierarchical method for representing, point cloud, voxel and/or event-based pixels, in accordance with an embodiment of the present invention;

FIG. 11A is an illustration of an exemplary multiple hierarchical 3-dimensional (3D) cube packing method for representing point cloud, voxel and/or event-based pixels, in accordance with an embodiment of the present invention;

FIG. 11B is an illustration of an exemplary flowchart of a compression apparatus and method for representing, not a limitation, point cloud, voxel and/or event-based pixels, in accordance with an embodiment of the present invention;

FIG. 11C is an illustration of an exemplary software module of a packing method and apparatus for representing, not a limitation, point cloud, voxel and/or event-based pixels, in accordance with an embodiment of the present invention;

FIG. 11D is an illustration of an exemplary flowchart of a packing method and apparatus for representing, not a limitation, point cloud, voxel and/or event-based pixels, in accordance with an embodiment of the present invention;

FIG. 12 is an illustration of an exemplary Submanifold Convolution (SubMConv3D), in accordance with an embodiment of the present invention;

FIG. 13 is an illustration of an exemplary Spatially Sparse Convolution (SparseConv3D), in accordance with an embodiment of the present invention;

FIGS. 14A-14C is an illustration of an exemplary Head and Tail Compression, in accordance with an embodiment of the present invention;

FIG. 15A is an illustration of an exemplary Octree Structure and FIG. 15B is an illustration of an exemplary Octree Structure combined with indices and mask-based compression, in accordance with an embodiment of the present invention;

FIG. 16 is an illustration of an exemplary block and neighboring blocks convolution, in accordance with an embodiment of the present invention;

FIG. 17 is an illustration of an exemplary Ratio Sparsity Formats and Blocks, in accordance with an embodiment of the present invention;

FIG. 18A is an illustration of an exemplary matrix and vector multiplication and FIG. 18B is an illustration of an exemplary matrix and matrix multiplication, in accordance with an embodiment of the present invention; and

FIGS. 19A and 19B illustrate an exemplary ratio sparsity matrix and vector multiplication, in accordance with an embodiment of the present invention;

FIG. 20 is a block diagram depicting an exemplary client/server system which may be used by an exemplary web-enabled/networked embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Voxel—a volumetric pixel (volume pixel or voxel) is the three-dimensional (3D) equivalent of a pixel and the tiniest distinguishable element of a 3D object. Voxel is a volume element that represents a specific grid value in a 3D coordinate space. However, like pixels, voxels may not contain information about their position in the 3D coordinate space. A voxel may contain at least one or more points in point cloud. Thus, voxel is also sparse in the 3D coordinate space.

Padding is a term relevant to convolutional neural networks as it refers to the number of pixels added to an image.

An octree is a tree data structure in which each internal node may have eight child nodes. Octrees may be used to partition a three-dimensional space by recursively subdividing it into eight octants.

LiDAR (Light Detection and Ranging) is a remote ranging device, which measures the distance to a target. The distance is measured by sending a laser pulse and recording the time lapse between outgoing light pulse and the detection of the reflected (back-scattered) light pulse. LiDAR may use eye-safe laser beams to “see” the world in 3D, providing machines and computers an accurate representation of the surveyed environment.

Point cloud is a set of data points in a 3D coordinate system, commonly known as the XYZ axes. Each point may represent a single spatial measurement on an object's surface. A point cloud may represent an entire external surface of the object. Point clouds are used for many purposes, including creating 3D computer-aided design (CAD) models.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settled law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognized in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. §0 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” include the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late-stage user(s) as opposed to early-stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising” And “contain” and variations of them—Such terms are open-ended and mean “including but not limited to”. When employed in the appended claims, this term does not foreclose additional structure or steps. Consider a claim that recites: “A memory controller comprising a system cache . . . .” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. sctn. 112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

All terms of exemplary language (e.g., including, without limitation, “such as”, “like”, “for example”, “for instance”, “similar to”, etc.) are not exclusive of any other, potentially, unrelated, types of examples; thus, implicitly mean “by way of example, and not limitation . . . ”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the disclosed and claimed subject matter may include the use of either of the other two terms. Thus, in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Moreover, any claim limitation phrased in functional limitation terms covered by 35 USC § 112(6) (post AIA 112(f)) which has a preamble invoking the closed terms “consisting of,” or “consisting essentially of,” should be understood to mean that the corresponding structure(s) disclosed herein define the exact metes and bounds of what the so claimed invention embodiment(s) consists of, or consisting essentially of, to the exclusion of any other elements which do not materially affect the intended purpose of the so claimed embodiment(s).

Devices or system modules that are in at least general communication with each other need not be in continuous communication with each other, unless expressly specified otherwise. In addition, devices or system modules that are in at least general communication with each other may communicate directly or indirectly through one or more intermediaries. Moreover, it is understood that any system components described or named in any embodiment or claimed herein may be grouped or sub-grouped (and accordingly implicitly renamed) in any combination or sub-combination as those skilled in the art can imagine as suitable for the particular application, and still be within the scope and spirit of the claimed embodiments of the present invention. For an example of what this means, if the invention was a controller of a motor and a valve and the embodiments and claims articulated those components as being separately grouped and connected, applying the foregoing would mean that such an invention and claims would also implicitly cover the valve being grouped inside the motor and the controller being a remote controller with no direct physical connection to the motor or internalized valve, as such the claimed invention is contemplated to cover all ways of grouping and/or adding of intermediate components or systems that still substantially achieve the intended result of the invention.

A description of an embodiment with several components in communication with each other does not imply that all such components are required. On the contrary a variety of optional components is described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

While embodiments herein may be discussed in terms of a processor having a certain number of bit instructions/data, those skilled in the art will know others that may be suitable such as 16 bits, 32 bits, 64 bits, 128s or 256-bit processors or processing, which can usually alternatively be used. Where a specified logical sense is used, the opposite logical sense is also intended to be encompassed.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Web sites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random-access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, removable media, flash memory, a “memory stick”, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Additionally, the phrase “configured to” or “operable for” can include generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium may include, but is not limited to, a hard drive, compact disc, flash memory, volatile memory, random access memory, magnetic memory, optical memory, semiconductor-based memory, phase change memory, periodically refreshed memory, quantum memory, and the like; the non-transitory computer readable medium, however, does not include a pure transitory signal per se; i.e., where the medium itself is transitory.

The present invention will now be described in detail with reference to embodiments thereof as illustrated in the accompanying drawings.

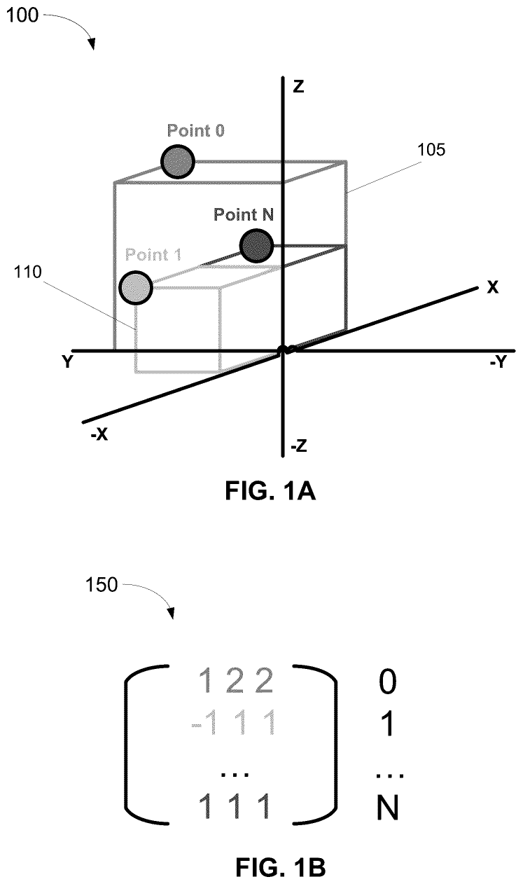

FIG. 1A is an illustration of an exemplary Point Cloud Coordinate System 100 and FIG. 1B is an illustration of an exemplary Point Cloud Coordinate System Data 150, in accordance with an embodiment of the present invention. FIG. 1A shows an image coordinate system axis 105 in blue, and point cloud coordinate system axis 110 in orange. FIG. 1B shows a point cloud coordinate system data represented as, not a limitation, a numpy array with N rows, and at least three (3) columns. Each row may correspond to a single point, which is represented using at least 3 data values for its position in space (x, y, z). If the point cloud data is from a LiDAR sensor, then the point cloud data may have additional values for each point, such as, not a limitation, “reflectance”, which may be a measure of how much of a laser light beam/pulse was reflected back by an obstacle in that position. In this case the point cloud data might be an N×4 array.

### Point Cloud Coordinates vs Image Coordinates

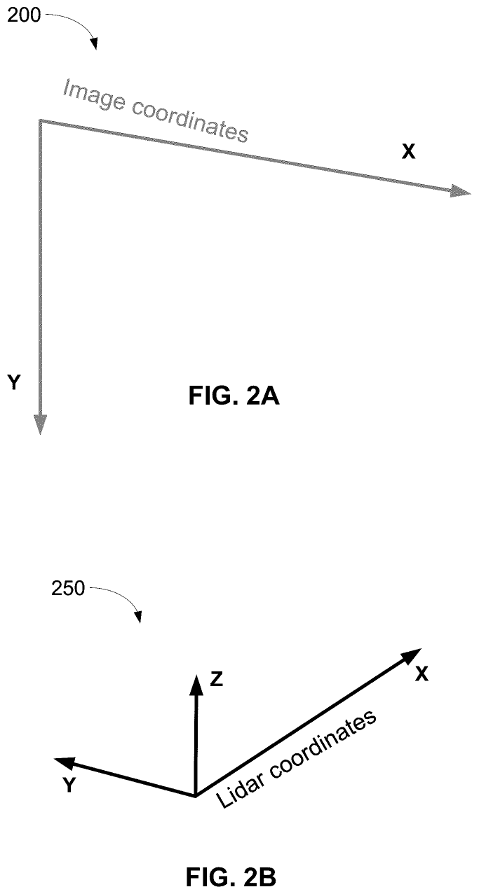

FIG. 2A and FIG. 2B are illustrations of an exemplary image coordinate system 200 and LiDAR or point cloud coordinate system 250, in accordance with an embodiment of the present invention. In one embodiment of the present invention, the axes for point cloud coordinate system 250 may have different meanings to the axes in image coordinate systems 200. FIG. 1A and FIG. 2A shows image coordinate system axes 105 in blue, and the point cloud coordinate system axes 110 in orange.

Referring to FIG. 2A, some general rules on image coordinate systems or images 200, not a limitation, may be as follows;
The coordinate values are always positive.
The origin is located on the upper left-hand corner.
The coordinates are integer value.

Referring to FIG. 2B, some general rules on LiDAR or point cloud coordinates or point cloud 250, not a limitation, may be as follows;
The coordinate values in point cloud may be positive (as shown) or negative.
The coordinates may take on real numbered values
The positive x axis represents forward
The positive y axis represents left
The positive z axis represents up

Previous related application(s) focusses on the sparsity on each element. Sparsity may also be possible to be applied to certain structures like, not a limitation, point cloud and Voxel. A volumetric pixel (volume pixel or voxel) is a three-dimensional (3D) equivalent of a pixel and the tiniest distinguishable element of a 3D object. The voxel is a volume element that may represent a specific grid value in a 3D space. However, like pixels, voxels do not contain information about their position in 3D space. A voxel may contain at least one or more points in point cloud. Thus, the voxel may also be sparse in the 3D coordinate space.

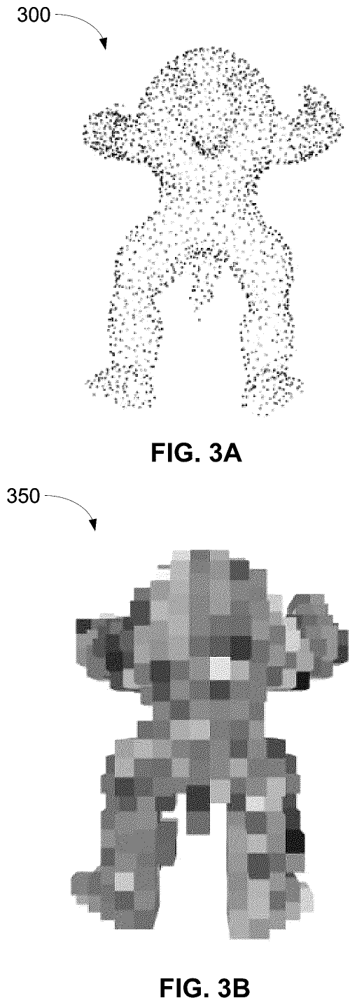

FIG. 3A and FIG. 3B shows the point cloud data 300 and voxel data 350 derived from an Open3D™ source, in accordance with an embodiment of the present invention. FIG. 3A shows an armadillo in point cloud data format 300 used as input to voxelization. And, FIG. 3B shows the armadillo in voxel data format 350 using the voxelization procedure.

FIG. 3A is an example of an armadillo in point cloud format 300. The total number of points are roughly 2000. The armadillo in point cloud format 300 is used as input to a voxelization procedure. A voxel grid 350 shown in FIG. 3B may be created from point cloud 300 using a method ‘create_from_point_cloud’ or voxelization procedure (see source code below). The voxel is occupied if at least one point of the point cloud is within the voxel. A color of the voxel is an average of all the points within the voxel. An argument ‘voxel_size’ may define a resolution of the voxel grid. A following exemplary source code from Open3D™ for creating voxel 350 from point cloud 300 is as follows;
print(‘input’)
N=2000
pcd=o3dtut.get_armadillo_mesh( )sample_points_poisson_disk(N) # fit to unit cube
pcd.scale(1/np.max(pcd.get_max_bound( )—pcd.get_min_bound( )), center=pcd.get_center( ))
pcd.colors=o3d.utility.Vector3dVector(np.random.uniform(0, 1, size=(N, 3)))
o3d.visualization.draw_geometries([pcd])
print(‘voxelization’)
voxel_grid=o3d.geometry.VoxelGrid.create_from_point_cloud(pcd, voxel_size=0.05)
o3d.visualization.draw_geometries([voxel_grid])

Many embodiments, and variations thereof, may provide for sparsity compression for point cloud and voxel.

A volumetric pixel, volume pixel or voxel is a three-dimensional (3D) equivalent of a pixel and the tiniest distinguishable element of a 3D object. The voxel is a volume element that represents a specific grid value in 3D space. Unlike pixels, voxels do not contain information about a voxel position in 3D space. The voxel may contain at least one or more points in point cloud. Thus, the voxel is also sparse in the 3D coordinate space.

In point cloud data format 300, the total number of points is roughly 2000. After the point cloud data 300 is converted to voxel data format 350, where point cloud data is input to the voxelization procedure, the points may be reduced to about 737 voxels by using the voxelization procedure. Each voxel may contain at least one point of the point cloud. The object may be in a 3D world coordinate, which means the points are in 3D coordinate [x, y, z]. Each point has attribute of [x, y, z, density]. The density may be a data value or a color value with [R, G, B] (three) values.

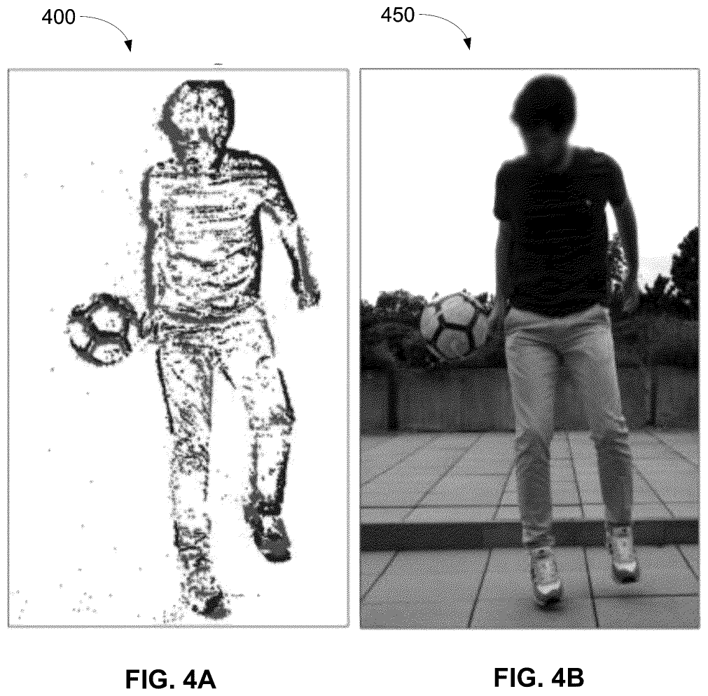

FIG. 4A and FIG. 4B is an illustration of an exemplary image-based camera output data 400 and event-based camera output data 450, in accordance with an embodiment of the present invention.

### Image-Based Camera vs Event-Based Camera

Event-based camera 450 has been widely used in many areas. In contrast to traditional cameras, whose pixels have a common exposure time, event-based cameras 450 are novel bio-inspired sensors whose pixels work independently and asynchronously output local changes in brightness. Each pixel may store a reference brightness level, and continuously compares it to the current brightness level. If the brightness level exceeds a certain threshold level, that pixel resets its reference level and generates an event such as, not a limitation, a discrete packet that contains the pixel address and timestamp. Events may also contain a polarity of the brightness level change, or an instantaneous measurement of the illumination level. Event-based cameras 450 may output an asynchronous stream of events triggered by changes in a scene illumination. The changes of the scene may be very sparse due to the threshold level and illumination level changes. Event-based pixels are sparse. Thus, the invention's method may be applied to Event-Based images.

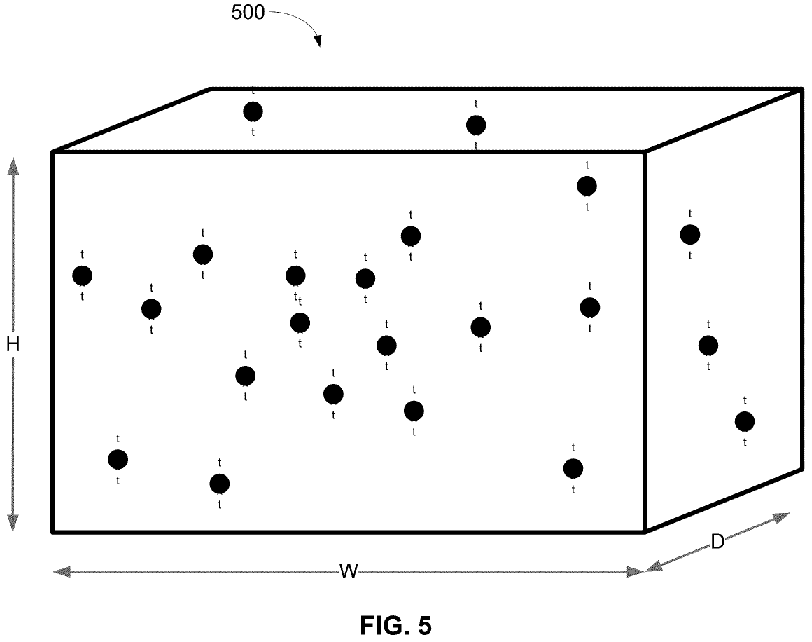

FIG. 5 is an illustration of an exemplary sparse point cloud format 500, in accordance with an embodiment of the present invention. A width (W), height (H) and Depth (D) as shown, not a limitation, may be required as a storage of W*H*D*vector (each pixel) to represent point cloud in sparse format.

Dense format of Point Cloud:

In the point cloud, dense formatting may be saved as follows;
[P0, P1, P2, P3, P4, . . . Pn], that is,
[[x0, y0, z0, density0], [k1, y1, z1, density1], [x2, y2, z2, density2], [x3, y3, z3, density3] . . . [xn, yn, zn, density]]

There may be different possibilities in terms of the order of points when storing the point cloud in dense format. For example, the order of pixels may be stored like:
[P1, P3, P0, P2, Pn, . . . P4] or [P3, P2, P1, Pn, P4, . . . P5] etc.

There may be a lot of possibility on the order when the point cloud data is saved. In such a format, it may be difficult to extract a pixel and its neighbor pixels to do convolutional operation.

### Sparse Format of Point Cloud:

If sparse format is used to store the point clouds, there may be a lot of zeros on the point cloud. Sparse format to store point clouds may waste a lot of storage space.

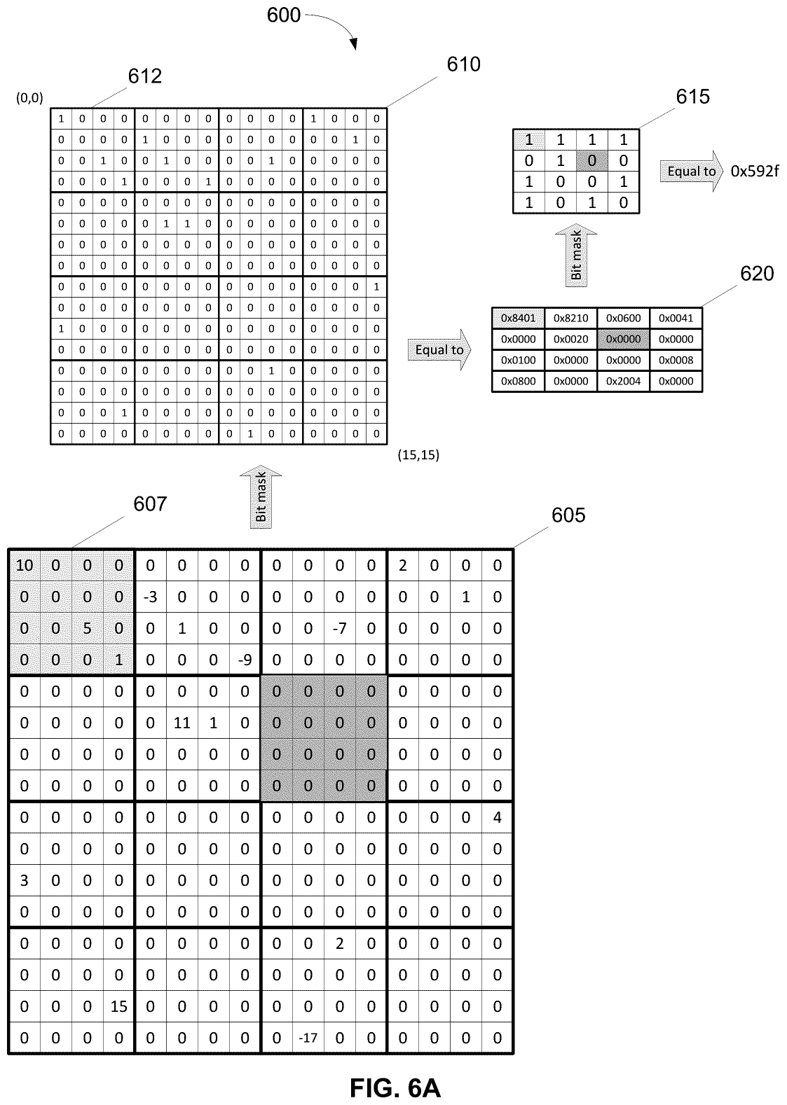

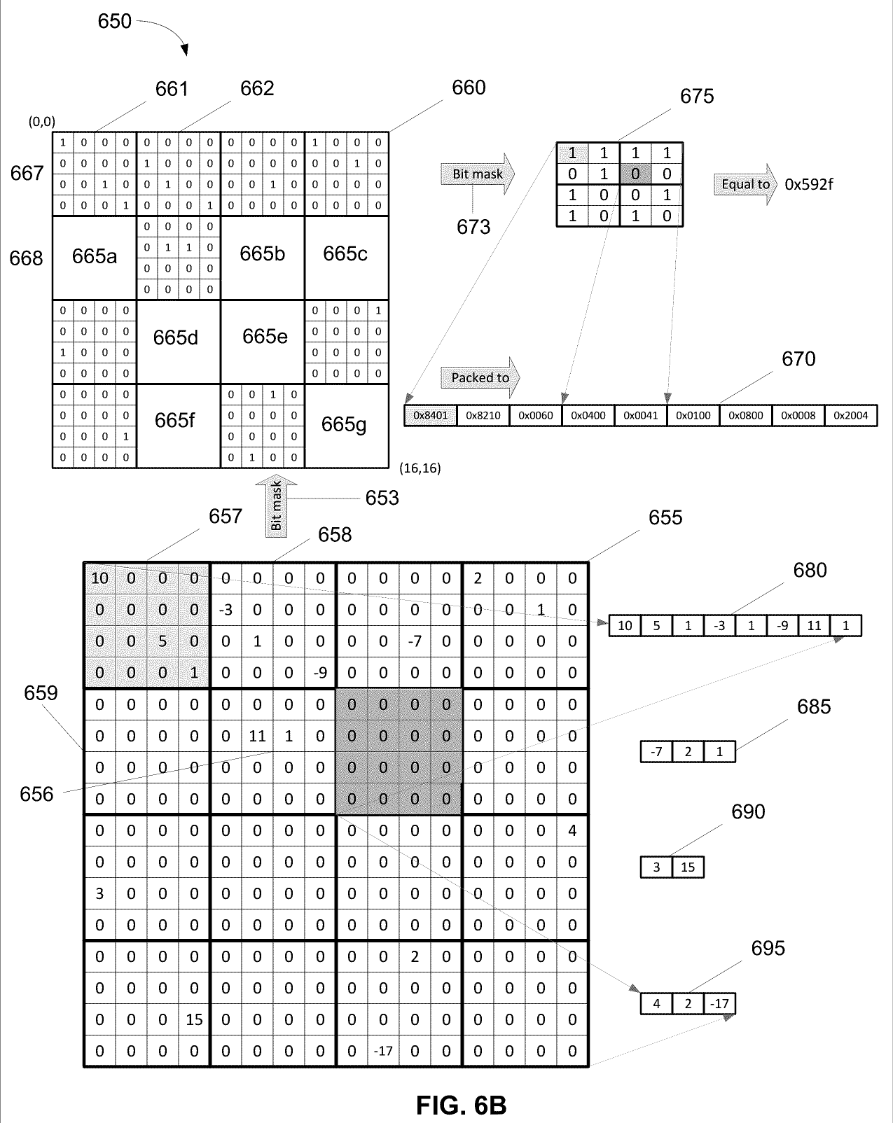

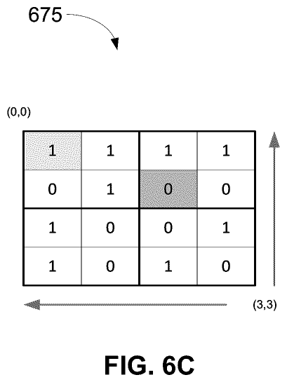

FIG. 6A is an illustration of an exemplary multiple hierarchical layers for storing sparse data format, in accordance with an embodiment of the present invention. In one embodiment of the present invention, first Level Bit mask 610 is used to mask point cloud 605, where a “1” bit represent 1 value. The result of the first level bit masking is shown in first level masking result 620. A second Level Bit mask 615 is used to mask first level masking result 620 where 1 bit represents a 4×4 array/sub-block. The result of the second level bit masking in this example is 0x592f. Sub-block 607 shows 4×4 pixels or 4×4 array values. The 4×4 array values are indicated in the top left of the 16×16 array values 605. The top left sub-block 607 is the lowest address of 16×16 array 605. The address of sub-block 607 is from top left corner, then increase one unit to the next contiguous x direction first, after finishing counting the first row of sub-block 607, then counts to next y direction. Thus, the value store in the array of the 4×4 sub-block of non-compressed value 607 may be as follows: [10, 0, 0, 0, 0, 0, 0, 0, 0, 0, 5, 0, 0, 0, 0, 1]. From the 4×4 array values, the bit mask of the non-compressed value may be generated as follows: [1, 0, 0, 0, 0, 0, 0, 0, 0, 0, 1, 0, 0, 0, 0, 1], where, a one “1” bit replaces any non-zero value of non-compressed sub-block 607. The reverse order of the bit mask in hex representative format is 0x8401, which is a first level compressed form of sub-block 612. Since 4×4 mask sub-block 612 has at least one non-zero value, the next/second level masking result shown in array/table 615 may have a 1 bit (yellow colored bit). The blue colored bit shows another 4×4 sub-block but with all zero bit masks. That is, all the values of this 4×4 sub-block are zeros. The first level compressed mask in table 620 shows the corresponding hex value of 0x0000. Second level mask 615 shows 1′b0.

FIG. 6B is an illustration of an exemplary multiple hierarchical layers to represent the location and value of a model including, not a limitation, a point cloud image, LiDAR image and/or camera image, in accordance with an embodiment of the present invention. FIG. 6B shows the compressed non-zeros value in 2×2 sub-blocks as a chunk/block 655. A sub-block 657 may represent a 4×4 array value (described in yellow color). 2×2 arrays of sub-blocks are packed together as a chunk/block. Top left 4×4 sub-block 657 (marked as yellow) has non-zero values: [10, 5, 1]. The next 4×4 sub-block 658 in the same row has non-zero values: [−3, 1, −9]. The first 4×4 sub-block 659 of the second row are all-zeros. The second 4×4 sub-block 656 of the second row has non-zero values: [11, 1]. The non-zero values of the four (4) 4×4 sub-blocks 656-659 are packed together in a first chunk table 680: [10, 5, 1, −3, 1, −9, 11, 1]. Next or second chunk table 685 includes the non-zero values: [−7, 2, 1] corresponding to the next four (4) 4×4 sub-blocks in the first and second rows. Then the non-zero values: [3, 15] is shown in chunk table 690 which corresponds to four (4) 4×4 sub-blocks in third and fourth rows, and a fourth table 695 includes non-zero values [4, 2, −17] which corresponds to the next four (4) 4×4 sub-blocks In one embodiment of the present invention, first Level Bit mask 660 is used to mask point cloud of block 655, where a 1 bit represents 1 value. A first level bit mask 653 is a 1 to 1 cell mapping from block 655 to block 660. If a cell in block 655 is a non-zero value, a corresponding cell in block 660 is marked as “1”. Otherwise, the cell is marked as “0”. For a sub-block within a 4×4 array size, if all cells in the 4×4 sub-block are marked as zeros, then the corresponding mask will be marked all zeros. In such case, the sub-block is left empty, which means skip that sub-block. For example, not a limitation, sub-block 665a corresponding to sub-block 659 may be left empty. A second Level Bit mask 673 is implemented in table 675 where a one (“1”) bit represents 4×4 array/sub-block 661 (e.g. first level 4×4 bit mask).

Diagram/Block/Chunk 660 shows all-zeros bit masks in sub-blocks 665a-665g. The all-zeros bit masks in sub-blocks 665a-665g may be skipped in hardware storage and software computing which saves storage space and computing time. Each bit mask in the second level masks of table 675 may represent a 4×4 sub-block of block 660. When all first level masks of a sub-block in block 660 are all-zeros (e.g., 665a-665g), the corresponding second level masks are marked as zero in table 675. Otherwise the second level mask is marked as one (“1”) in table 675. The second level mask bits from lowest bit to the highest bits are: [1, 1, 1, 1, 0, 1, 0, 0, 1, 0, 0, 1, 1, 0, 1, 0]. The high to low address hex representative is 0x592f. In other words, the result of the second level bit masking is 0x592f. The values of the second Level Bit masking shown in table 675 are packed in table 670.

Diagram/Block/Chunk 660 may include first level masks and some all-zeros masks in certain sub-blocks (e.g., 665a-g). The non-zero masks in the non-zero sub-blocks may be packed as shown in table 670. The first sub-block masks of block 660 may include 4×4 sub-block masks. In first sub-block 661 of a first row 667 of block 660, from low to high bit representation, the bit value of the first row is: [1, 0, 0, 0], the second row: [0, 0, 0, 0], the third row: [0, 0, 1, 0], and the fourth row is: [0, 0, 0, 1]. In a high to low bit representation (e.g. a reversing the low to high bit representation) of the same sub-block 661: the fourth row may include: [1, 0, 0, 0], then the third row: [0, 1, 0, 0], the second row: [0, 0, 0, 0], then the first row may include: [0, 0, 0, 1]. When packed together from the high to low bit representation, a result may include: [1, 0, 0, 0, 0, 1, 0, 0, 0, 0, 0, 0, 0, 0, 0, 1]. As a hex representative, that is every four-bit masks in the high to low bit representation makes a hex representative as follows: [1, 0, 0, 0]=0x8, [0, 1, 0, 0]=0x4, [0, 0, 0, 0]=0x0, and [0, 0, 0, 1]=0x1. That is, 4×4 sub-block 661 is packed as 0x8401 shown in a first cell in table 670. The 2×2 sub-blocks' masks may be packed together. For a next or second sub-block 662 in same row 667 in chunk/block 660, masks from low to high are deciphered as follows: The first row is: [0, 0, 0, 0], the second row is: [1, 0, 0, 0], the third row is: [0, 1, 0, 0], and the fourth row is: [0, 0, 0, 1]. Again, the bits are packed from high to low representation/order. Then the packed result will be 0x8210 shown in a second cell in table 670. The first sub-block 665a in a second row 668 of blocks 660 has all-zeros masks. The first level masks may be skipped in the packing process. The next sub-block is the last sub-block in the same row 668 because the next third and fourth sub-blocks are zeros or empty. The masks from the low to high order are derived as follows. The first row's mask is: [0, 0, 0, 0], the second row's masks: [0, 1, 1, 0], the third row's masks: [0, 0, 0, 0] and the fourth row's masks: [0, 0, 0, 0], Again, the bits are packed from high to low bit ordering and the result will be 0x0060 shown as third cell in table 670. After packing the four sub-block masks together, (Remember, the third sub-block 665a is all zeros and was skipped) then the result will be: 0x8401, 0x8210, 0x0060 shown in table 670. Following the same packing rule, the next four (4) 4×4 sub-blocks have two non-zero sub-blocks. The first level masks are packed as: 0x0400, 0x0041 shown in table 670. Then in the remaining two (2) 8×8 sub-blocks, the first level masks are packed as: 0x0100, 0x0800, 0x0008 and 0x2004.

FIG. 6C is an illustration of an exemplary 4×4 second level mask table 675 and how to decipher a hex representation of table 675, in accordance with an embodiment of the present invention. For example, not a limitation, from the lowest bit to highest bits are: 1111 (row 0), 0010 (row 1), 1001 (row 2), and 1010 (row 3). When packed from high to low representative in hex format, [0, 1, 0, 1] (row 3)=0x5, [1, 0, 0, 1] (row 2)=0x9, [0, 1, 0, 0] (row 1)=0x2, then [1, 1, 1, 1] (row 0)=0xf. The four rows of table 675 may then be packed as: 0x592f.

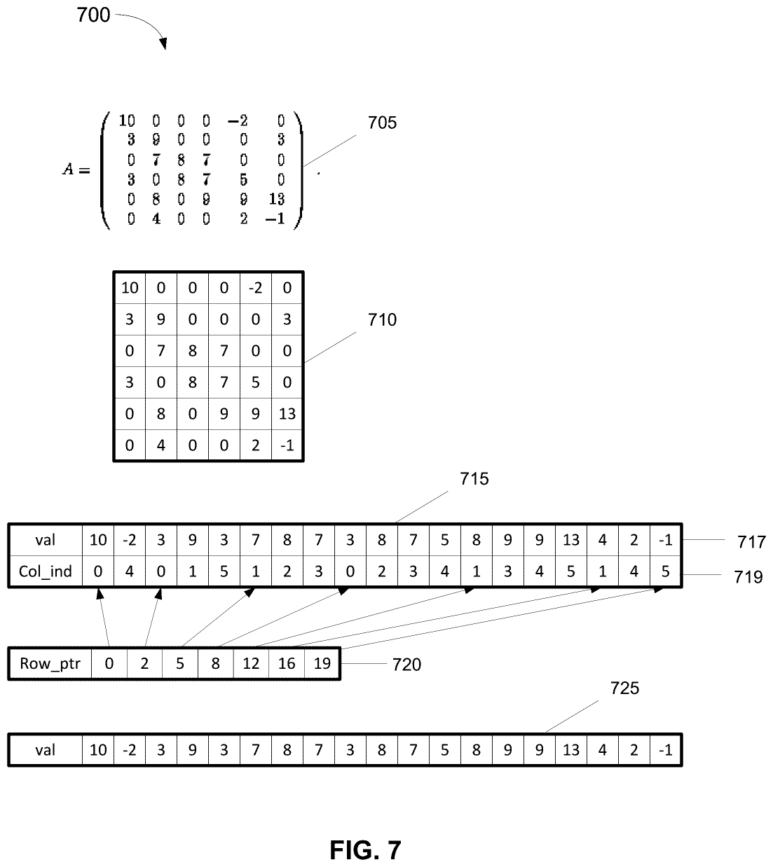

FIG. 7 is an illustration of an exemplary CSR (Compress Sparse Row) format 700, in accordance with an embodiment of the present invention. Matrix A 705 may be described as a table 710 with a 6×6 array. In a row 0 (top row), non-zero values are shown as: [10, −2] in column index: [0, 4]; In row 1, non-zero values are shown as: [3, 9, 3] in column index: [0, 1, 5]; In row 2, non-zero values are: [7, 8, 7] in column index: [1, 2, 3]; In row 3, non-zeros values are: [3, 8, 7, 5] in column index: [0, 2, 3, 4]; In row 4, non-zero values are: [8, 9, 9, 13] in column index: [1, 3, 4, 5]; In row 5, non-zero values are: [4, 2, −1] in column index: [1, 4, 5]. Then the values may be packed together. The value row is shown in table 715. The column indices may also be packed together. using the col_ind row indices 719. Then, a Row_ptr 720 may be determined as follows. From row 0, the element 0 of table 715 may be packed. Then, the value of row_ptr 0 in table 720 may be used to indicate the start position of row 0 of table 710. Since in row 0, there are two non-zero elements [10, −2], then row 1 may be started from position 2. Then a value [e.g., 2] of the second cell of row_ptr 720 may indicate the start position of row 1. In row 1 of table 710, there are three non-zeros values [3, 9, 3], then a position in row_ptr is 2+3=5. Thus, row 2 in table 710, starts from the position of 5; row 3, start on position 8. Then, rows 4, 5, 6, start on positions 12, 16 and 19. When Row_ptr 720 values are packed together, the resultant values are: [0, 2, 5, 8, 12, 16, 19]. For the very sparse matrix, approximately 10% have non-zero values. The CSR might be a good choice for packing the non-zeros together. Especially, when the pixel values are taken from LiDAR or event camera, where there are more pixels around the object. Otherwise, it will be very sparse. The multiple hierarchical block packed schemes may be mixed to compress the data. For example, in the first level of the compression process, the bit mask may be used to compress data and for the second level of the compression process, the CSR format may be used to compress data, or vice versa.

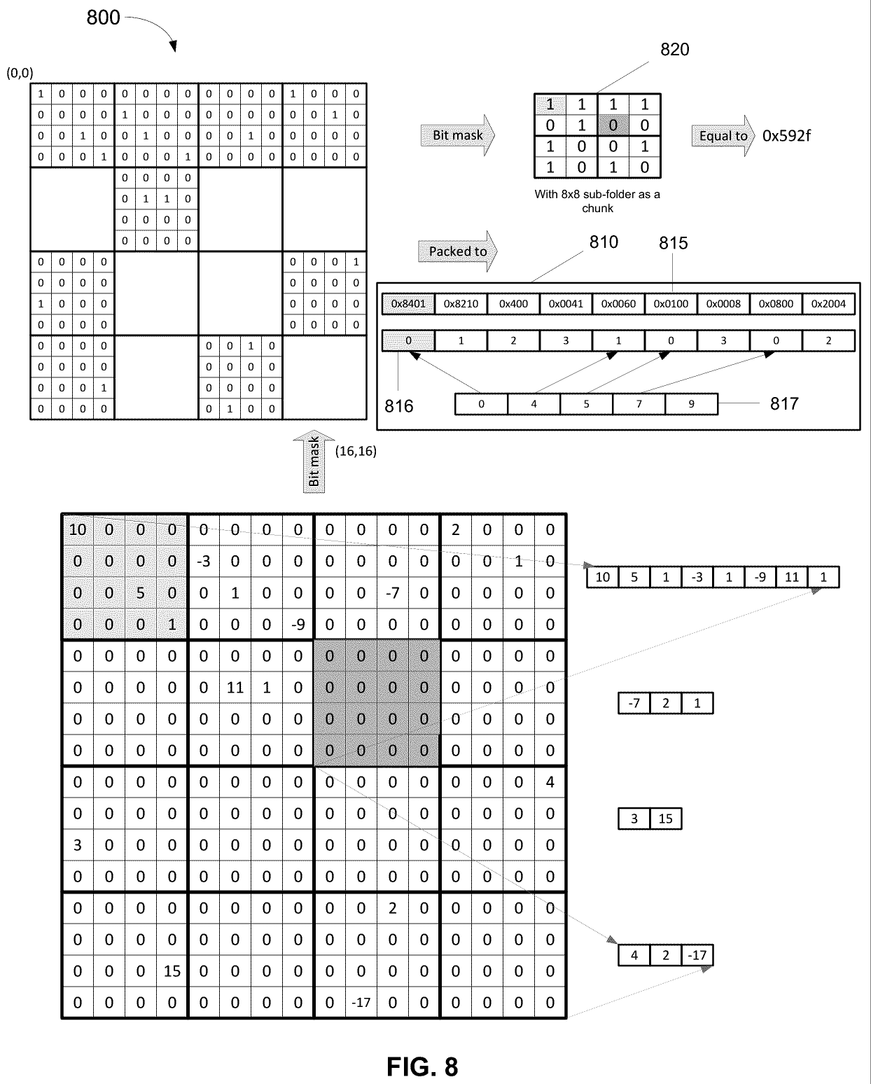

FIG. 8 is an illustration of an exemplary multiple hierarchical layers with CSR (compress sparse row) 800 to represent a location and value of, not a limitation, point cloud, a voxel or pixel, in accordance with an embodiment of the present invention. The multiple hierarchical layers store sparse data format as shown in FIG. 6B, is identical to FIG. 8 except for block 670 being replaced by block 810, in a CSR compression format. In one embodiment of the present invention, bit masks may be used as a first level compression, and the CSR may be used as a second level compression. In a second level bit masks shown in table 820: Row 0 has bit masks: [1, 1, 1, 1], row 1 has bit masks: [0, 1, 0, 0], row 2 has bit masks: [1, 0, 0, 1], row 3 has bit masks: [1, 0, 1, 0]. The first level sub-block masks in row 0 are packed in 0x8401, 0x8210, 0x0400, 0x0041 and the corresponding column index are: [0, 1, 2, 3] arranged in column index table 816; Row 1 are packed as: 0x0060 and the corresponding column index are: [1]; Row 2 are packed as: 0x0100, 0x0008 and the column index are: [0, 3]; Row 3 are packed as: 0x0800, 0x2004 and column index are: [0, 2]. Row_ptr will be 0 for row 0. If row 1 has 4 non-zero sub-blocks, then the row_ptr for row 1 will point to 4. If row 1 has 1 non-zero sub-block, then the row_ptr will point to 4+1=5 for row 2. Then row_ptr for row 3 and row 4 will be pointing to: 7 and 9 as shown in row_ptr table 817.

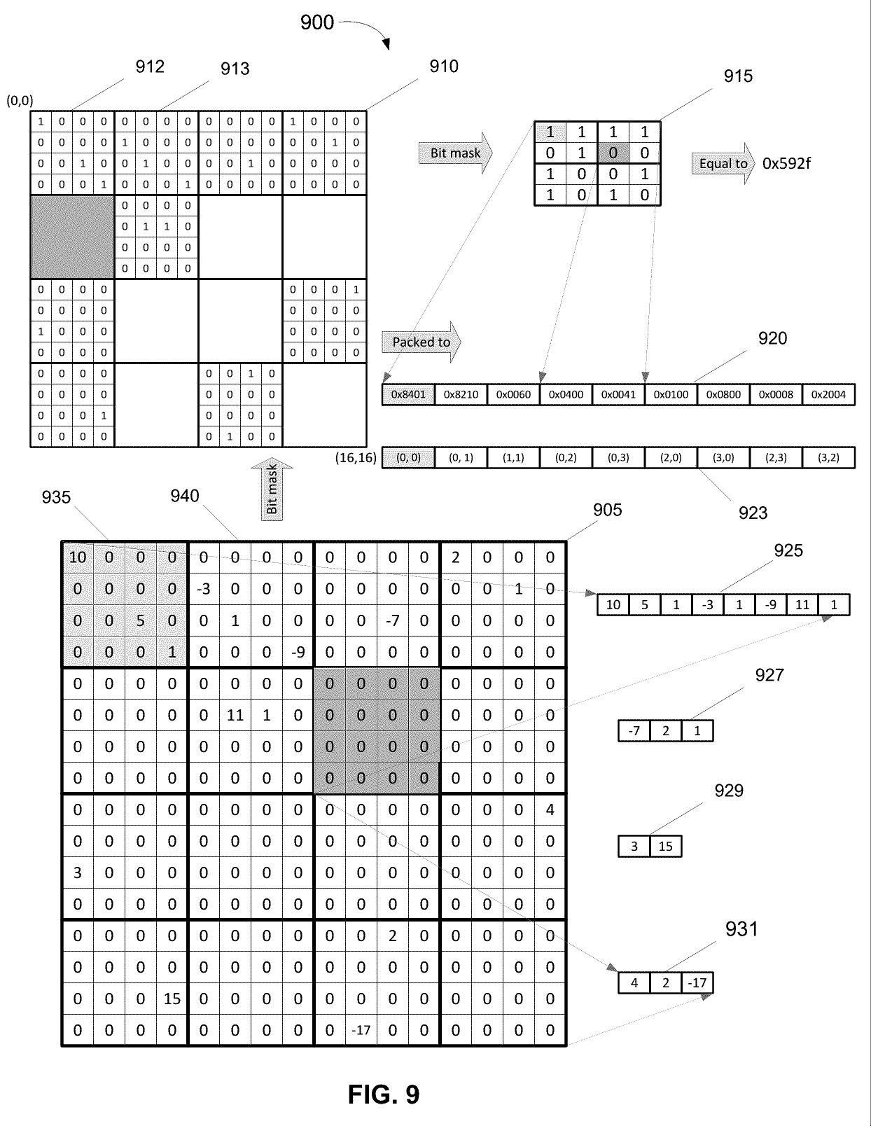

FIG. 9 is an illustration of an exemplary multiple hierarchical method 900 to represent, not a limitation, point cloud, voxel and/or event-based pixels, in accordance with an embodiment of the present invention. In one embodiment of the present invention, index (Row, Col) shown in an array 923, is used to indicate the location of a non-zero sub-block within a block (or a chunk). Inside the block or chunk, a mask-based compression is utilized to indicate the location of the compressed values of an image. FIG. 9 is also an illustration that the compressed values could be the “reflectance” value from a LiDAR sensor and the position of mask or (row, col) could be the x, y position. It may also apply to the event driven camera. The compressed values could be the brightness value changes from frame to frame or time sequence. The mask could indicate the x, y location of the picture or frame. The value could be a voxel or pixel in such application. In an embodiment of the present invention, a first level bit mask table 910 (e.g. top-left block 912) may represent the lowest bit where one (1) bit may represent one (1) value. In a top-left 4×4 sub-block 935 of block/table 905, a non-zero mask 912 is 16′b1000 0100 0000 0001=0x8401 which represents the location of non-zero values [10, 5, 1] in sub-block 935. In a next 4×4 sub-block 940, a non-zero mask 913 is 16′b1000 0010 00001 0000 which represents the location of non-zero values [−3, 1, −9] of sub-block 940. Top-left 8×8 first level bit mask array/sub-block in block 910 may be packed in a mask packing array 920, which may result as masks: [0x8401, 0x8210, 0x0060] (e.g. first three elements of array 920). A 4×4 all-zero bit masks don't need to be saved because the bit masks isure all-zeros. For the non-zeros of the 8×8 mask sub-block or four (4) 4×4 sub-blocks, the masks are packed as: [0x8401, 0x8210, 0x0060] shown as the first three element in packed array 920. The corresponding indices or location indicator of the non-zero 4×4 subblocks are (0,0), (0,1), (1,1) shown as the first three element in indices array 923. The non-zero value of the 8×8 sub-block may be packed as: [10, 5, 1, −3, 1, −9, 11, 1] shown in non-zero table 925. The packing of the 16×16 block 910 is repeated until a final total hardware storage may be determined including storage of indices or non-zero location indicators: (0,0), (0, 1), (1,1), (0,2), (0,3), (2,0), (3,0), (2,3), (3,2) shown in array 923, packed masks (0x8401, 0x8210, 0x0060, 0x0400, 0x0041, 0x0100, 0x0800, 0x0008, 0x2004) shown in array 920, and non-zero values (10, 5, 1, −3, 1, −9, 11, 1, −7, 2, 1, 3, 15, 4, 2, −17) (shown in non-zero arrays/tables 925-931). A small amount of hardware storage may be used for the compressed data of the original block data 905. Reverting and extracting the compressed data into an uncompressed data may then be relatively simple.

The above description is just one kind of sequence. In some embodiments, different sequences for packing the indices, masks and compressed values may be implemented.

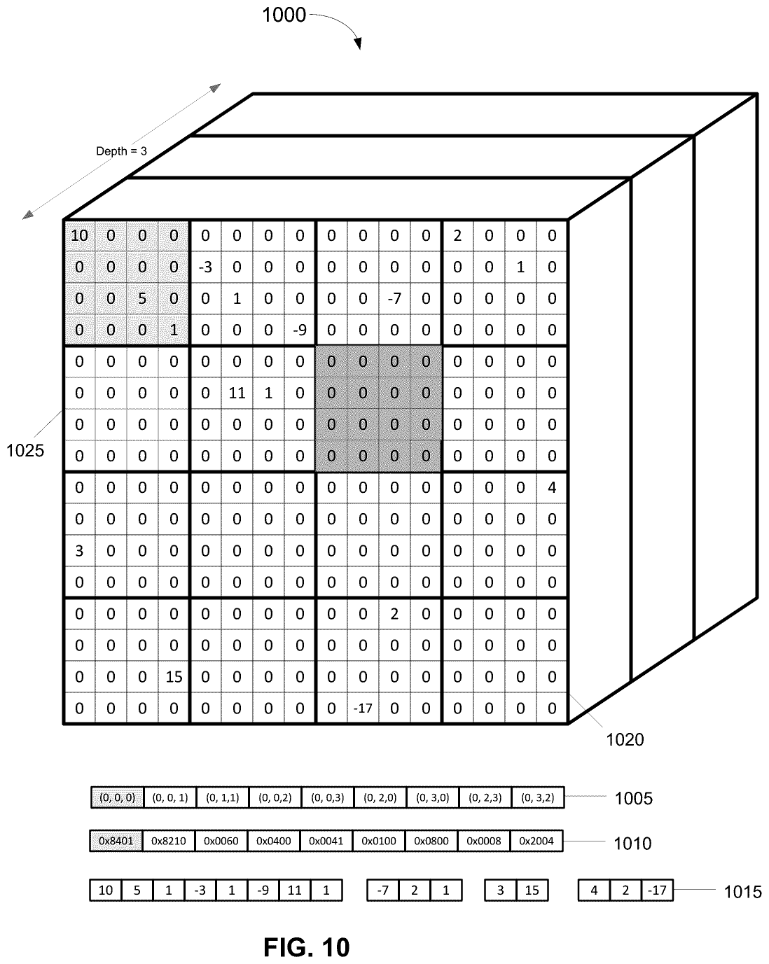

FIG. 10 is an illustration of an exemplary multiple hierarchical method 1000 for representing, not a limitation, point cloud, voxel and/or event-based pixels, in accordance with an embodiment of the present invention. For a 3-dimensional (3D) data, similar packing scheme like Point cloud may be implemented using (Depth, Row, Col) indexing and block to represent the point cloud, voxel and Event-based pixels. Packing with 2-dimensional (2D) images may be utilized. For example, if Depth=N, then there may be N record(s) of 2D images to be packed as follows: Depth (=N)*(number of 2D images). The 3D data may be leveraged by 2D images. For instance, if Depth=0, then a first 2-dimensional (2D) image may be packed. If Depth=1, then a second 2D image may be packed. If Depth=2, then the last or third 2-dimensional (2D) image may be packed. A 3D image may be compressed like a 2D image. For example, indices 1005 shows:

(depth,y,x)=[(0,0,0),(0,0,1),(0,1,1),(0,0,2),(0,0,3),(0,2,0),(0,3,0),(0,2,3),(0,3,2)].

Since depth=0, the 3D image may be compressed like a 2D image.

For the first 8×8 block on the top left of block 1020, there are 2×2 sub-blocks. The sub-block (row, column)=(y, x)=(0, 0), (0, 1), (1, 0) and (1, 1). Sub-block (1, 0) 1025 has all-zeros values. Then the sub-block skip. Then, we add the depth into this. (depth, y, x)=(0, 0, 0), (0, 0, 1), (0, 1, 1). Then, we can use the same method for the next block. There are 2×2 sub-blocks (row, column)=(0, 2), (0, 3), (1, 2) and (1,3). The sub-block (1, 2) and (1, 3) are all-zeros sub-block, which is skipped. For this block, there are two sub-block with non-zero values, (row, column)=(0, 2) and (0, 3). With depth=0, (depth, y, x)=(0, 0, 2), (0, 0, 3). Then the same packing rule may be implemented, where the rest (0, 2, 0), (0, 3, 0), (0, 2, 3) and (0, 3, 2) are shown in table 1005. The corresponding mask of these sub-blocks are 0x8401, 0x8210, 0x0060, 0x0400, 0x0041, 0x0100, 0x0800, 0x0008 and 0x2004 shown in table 1010. For the packed value of these sub-blocks, the value packed is shown in table 1015.

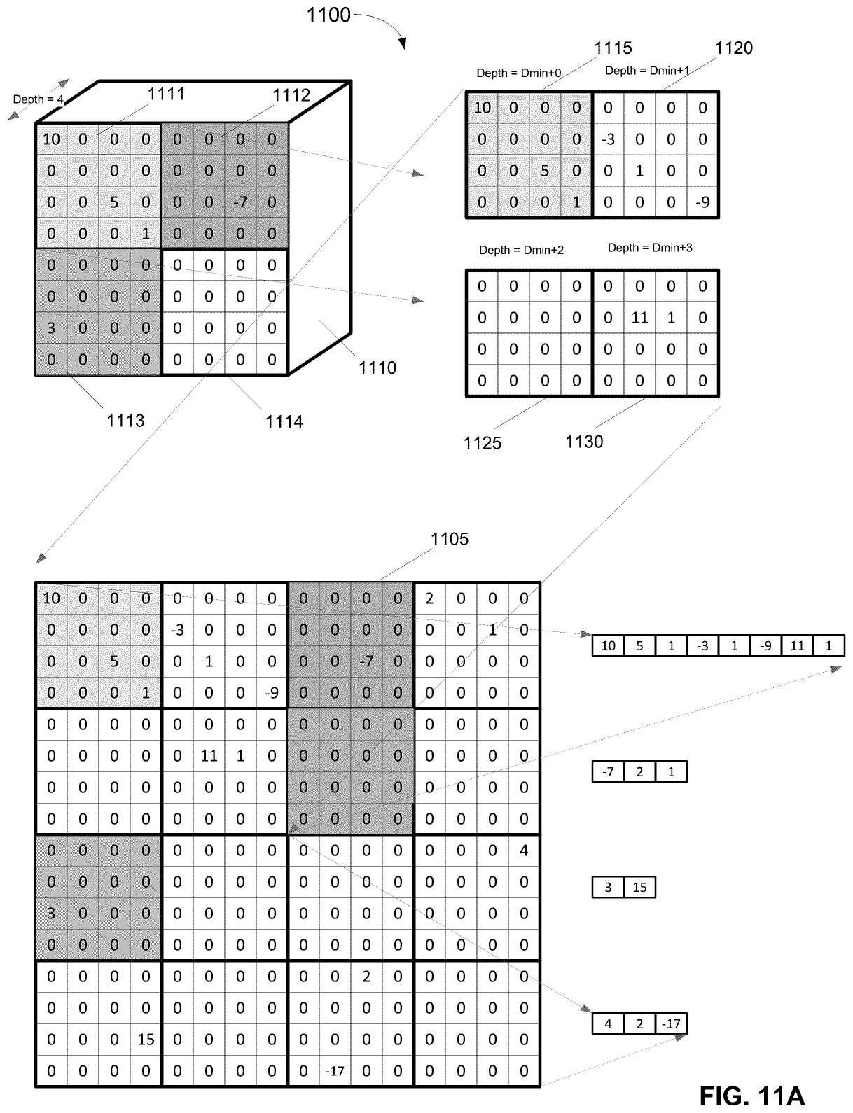

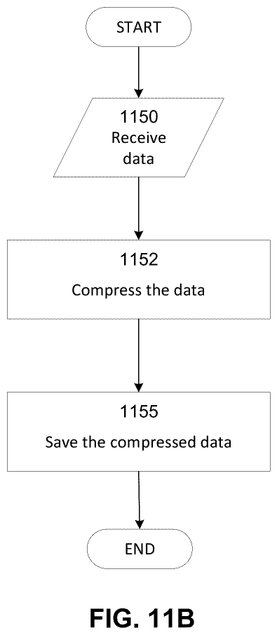

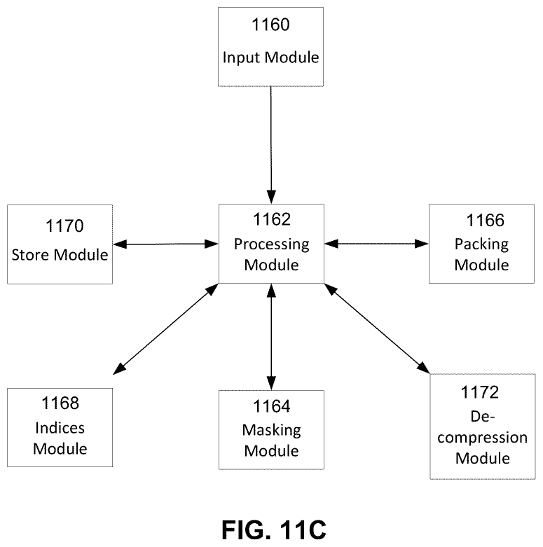

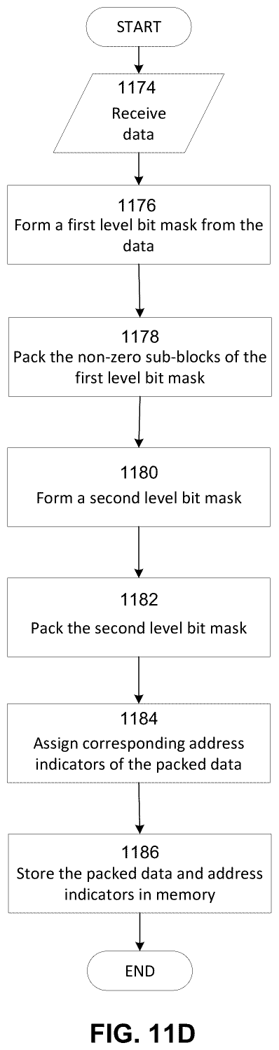

FIG. 11A is an illustration of an exemplary multiple hierarchical 3-dimensional (3D) cube packing method 1100 for representing, not a limitation, point cloud, voxel and/or event-based pixels, in accordance with an embodiment of the present invention. In an embodiment, a 3-dimensional (3D) cube 1110 may be packed by leveraging 2-dimensional (2D) images. For example, packed cube 1110 having a dimension (Depth, Row, Column) of (4, 8, 8) is shown. A first sub-cube 1111 of packed cube 1110 is set as (Depth, Row, Column)=(4, 4, 4) (shown in yellow color). First sub-cube 1111 may be reshaped from (Depth, Row, Column)=(4, 4, 4) to 2D images (Row, Column)=(8, 8) shown in arrays 1115, 1120, 1125 and 1130. For array 1120 (depth=1), array 1125 (depth=2) and array 1130 (depth=3) are not able to see in sub-cube 1111. The 8×8 block is the corresponding 8×8 block in a top left corner of block 1105. We keep reshaping the second sub-cube 1112 (in green color), third sub-cube 1113 (in orange color) and fourth sub-cube 1114 (in white color), then the other three 8×8 blocks shown in block 1105 are reshaped. Then, it is very similar to 2D images. The 2D images may then be packed just like in the 2D packing process example shown in FIG. 9. The only difference may be the neighbor pixels. To do a 3-dimensional (3D) convolution, the neighbor pixels are neighbor cubes, not the neighbor pixels after getting reshaped or extended.

FIG. 11B is an illustration of an exemplary flowchart of a compression method and apparatus for representing, not a limitation, point cloud, voxel and/or event-based pixels, in accordance with an embodiment of the present invention. In one embodiment of the present invention, input data representing point cloud, voxel or event-based pixel data may be compressed and stored. For example, input data may be received in a Step 1150. The received data may be compressed in a Step 1152. The compressed data may be stored in memory in a Step 1155. The compressed data may replace the input data but stored in a smaller hardware memory, saving hardware memory.

FIG. 11C is an illustration of an exemplary software module of a packing method and apparatus for representing, not a limitation, point cloud, voxel and/or event-based pixels, in accordance with an embodiment of the present invention. In one embodiment of the present invention, the software module may comprise, not a limitation, an input module 1160, a processing module 1162, a masking module 1164, a packing module 1166, an indices module 1168, a store module 1170, and a de-compression module 1172. Input module 1160 may arrange input data. For example, not a limitation, in a 16×16 array or four (4) 8×8 arrays, each 8×8 array containing four (4) 4×4 arrays of point cloud, voxel or event-based pixel data. Masking module 1164 may create, not a limitation, a first level and a second level mask. The first level mask may be used to mask the input data where the input data may represent point cloud, voxel or event-based pixel data. The first level mask may contain the same number of cells as the input data. That is, the first level mask is a copy of the input data except a one (“1”) bit in the first level mask represents one (1) non-zero value of the input data. The second level mask is used to mask the first level masking result where a one (“1”) bit represents a 4×4 array of the first level mask. Packing module 1166 packs the bit masks of each non-zero 4×4 array in the first level mask into their hex representation and saves the hex representations in a table, as shown in FIG. 9. Indices module 1168 creates an address indicator of each packed 4×4 mask. Store module 1170 saves the packed 4×4 mask and the address indicator of each packed 4×4 mask. Since only compressed data is saved, only a portion of hardware storage is used as compared to saving the raw input data. De-compression module 1172 may easily revert back the saved packed data into the original data.

FIG. 11D is an illustration of an exemplary flowchart of a packing method and apparatus for representing, not a limitation, point cloud, voxel and/or event-based pixels, in accordance with an embodiment of the present invention. Referring to FIG. 11D and FIG. 9, in a Step 1174 data is received where data 905 may represent point cloud, voxel and/or event-based pixels data. In a Step 1176, first level bit mask 910 may be created based on the received data where a one (“1”) bit replaces a non-zero value of input data 905. In a Step 1178, 4×4 non-zero sub-block mask(s) may be packed by representing the 4×4 sub-block mask(s) 912, 913, etc. in hex and saved in a packed mask table 920. In a Step 1180, second level bit mask 915 is formed which is a further mask of the first level masking result where 1 bit represents a 4×4 array of first level bit mask 910. In a Step 1182, second level bit mask 915 is packed where the packed value is equivalent to 0x592f. In a Step 1184, corresponding address indicators 923 are assigned to packed masks 920. In a Step 1186, address indicators and corresponding packed masks 920 are stored in memory.

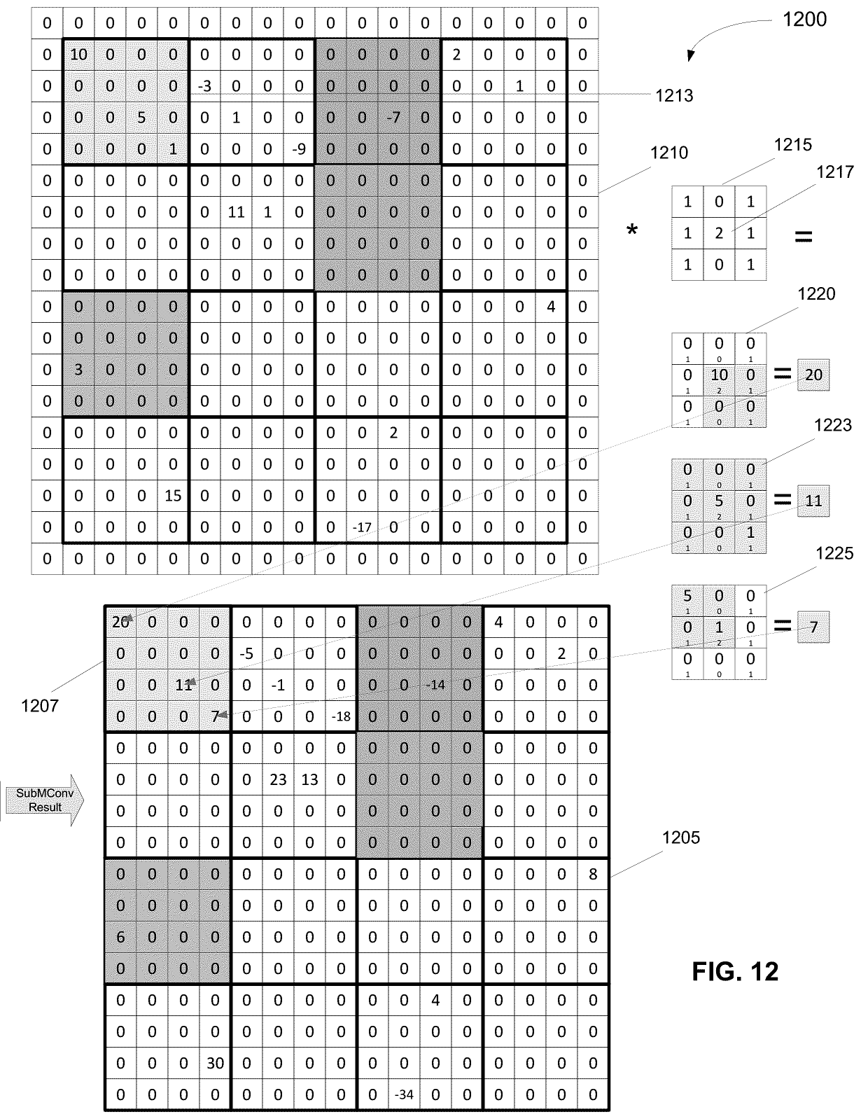

FIG. 12 is an illustration of an exemplary Submanifold Convolution (SubMConv3D) 1200, in accordance with an embodiment of the present invention. In one embodiment of the present invention, submanifold convolutions may not add to active sites after doing the convolution operation. In the figure shown, a convolution kernel may be set as 3×3 with zero padding on a 2D image. The convolution may apply on the location with non-zero pixels. A final convolution result of 20, 11 and 7 may be obtained. For example, not a limitation, a main filter (size=3×3) 1215 may be utilized. A padding is applied on the boundary of table 1210 with zeros. A center value 1217 of main filter 1215 may perform the convolution operation with non-zero values. In the top left, yellow sub-block 1213, numbers (10, 5, 1) are the non-zero values. The center of main filter 1215 (e.g. ‘2’) may be applied to the non-zero values (10, 5, 1) of sub-block 1213. For instance, not a limitation, center 1217 of main filter 1215 is a number ‘2’ that may apply to the location of non-zero value ‘10’. The convolution result of ‘20’ may be derived as follows: 0*1+0*0+0*1+0*1+10*2+0*1+0*1+0*0+0*1=20 (e.g. main filter 1215*first table 1220=20). The second non-zero value is ‘5’. Next, the center of main filter 1215 (e.g. ‘2’) is applied to the location of non-zero value 5. The convolution result of ‘11’ may be derived as follows: 0*1+0*0+0*1+0*1+5*2+0*1+0*1+0*0+1*1=11 (e.g. main filter 1215*second table 1223=11). The third non-zero value is 1. The main filter may be applied to get the convolution result ‘7’ as follows: 5*1+0*0+0*1+0*1+1*2+0*1+0*1+0*0+0*1=7 (e.g. main filter 1215*third table 1225=7).

Following the submanifold convolution rule above, sub-block 1207 of table 1205 may be obtained, as shown. The quantity of non-zero values in sub-block 1207 may not increase because the center of the main filter applies to the non-zero location(s) of sub-block 1213.

FIG. 12 also shows a 2-dimensional (2D) convolution. That is, the feature map in the example is in the 2-dimensional (2D) (x, y) direction, and applying the main filter (e.g. 3×3 filter) to the 2D feature map. For a 3-dimensional (3D) submanifold convolution, a 3D feature map in the (x, y, z) direction may be utilized. After which, a 3D main filter (e.g. 3×3×3 filter) may be applied to the 3D feature map.

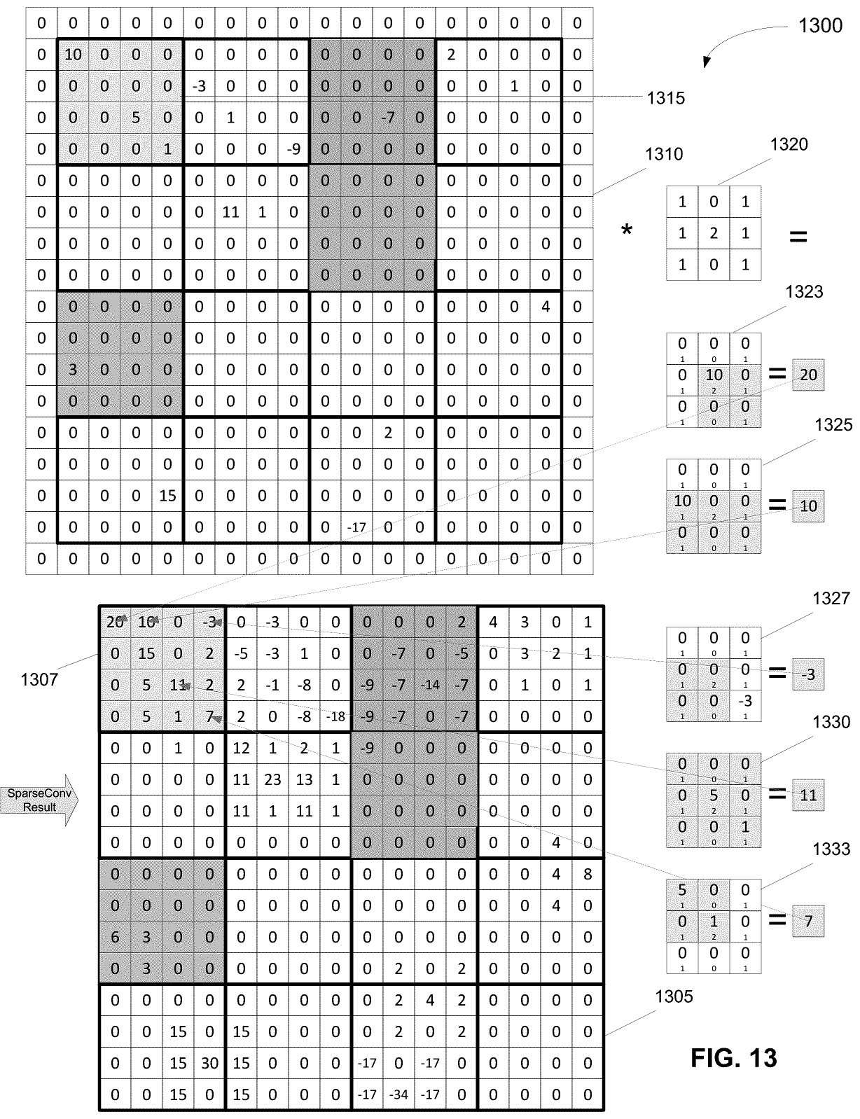

FIG. 13 is an illustration of an exemplary Spatially Sparse Convolution (SparseConv3D) 1300, in accordance with an embodiment of the present invention. In one embodiment of the present invention, sparse convolutions 1300 are like regular convolution but saves a log of computation by exploiting the sparsity in the input data. In a regular convolution, convolution filters may be applied per location according to the stride_x and stride_y. For more common cases, the stride_x and stride_y will be a “1”. Then a 3×3 filter is moved to an x direction by one (1) step. Then multiply the filter value with the feature and sum up as a final pixel. Then move 1 to a next x direction until the whole process is done. Later the next y direction is moved until the whole image is finished. In the example shown, not a limitation, a convolution kernel 1320 may apply on a 2D image 1310 with zero padding. The sparse convolution is somewhat similar to the submanifold convolution of FIG. 12 with a few exceptions. The final convolution result of 20, 10, −3, 11, 7 shown for tables 1323-1333 may be derived as follows:

The center of main filter 1320 may apply to any location of the 2-dimensional (2D) feature map. Main filter 1320 may include, not a limitation, a 3×3 filter. A zero padding may be applied on the boundary of table 1310. Main filter 1320 may apply to each location of sub-block 1315 shown in a top left portion of table 1310. The first value in the top left sub-block 1315 is number ‘10’. Main filter 1320 may be applied to a first table 1323 to get the first convolution result ‘20’: 0*1+0*0+0*1+0*1+10*2+0*1+0*0+0*1=20 (e.g. main filter 1320*first table 1323=20). To arrive at the convolution result ‘10’, a stride_x=1 and a stride_y=1 may be implemented which means, move to a next x direction by one (1) and apply main filter 1320 to the location to get the convolution result ‘10’: 0*1+0*0+0*1+10*1+0*2+0*1+0*1+0*0+0*1=10 (e.g. main filter 1320*second table 1325=10). The next operation and value will be: 0*1+0*0+0*1+0*1+0*2+0*1+0*1+0*0+(−3)*1=−3 (e.g. main filter 1320*third table 1327=−3). The same rules above are followed to arrive at the remaining convolution results 11 and 7 shown on sub-block 1307 of table 1305. The examples above, not a limitation, may apply to an instance of a 2-Dimensional (2D) spatially sparse convolution where the 2D feature map in the example is in the 2D (x, y) direction before the main filter is applied to the 2D feature map. In terms of 3D spatially sparse convolution, a 3D main filter having a size of roughly 3×3×3 may be applied to a 3D feature map in the (x, y, z) direction to arrive at a sparse convolution result.

### 3D Convolutions

The 3D convolutions may apply a 3-dimensional main filter to the data and the filter moves to 3-direction (x, y, z) to calculate the low-level feature representations. The output shape is a 3-dimensional (3D) volume space such as, not a limitation, cube or cuboid. 3D convolutions of the present invention may be helpful in event detection in, not a limitation, videos, 3D medical images, LiDAR point cloud processing, etc.

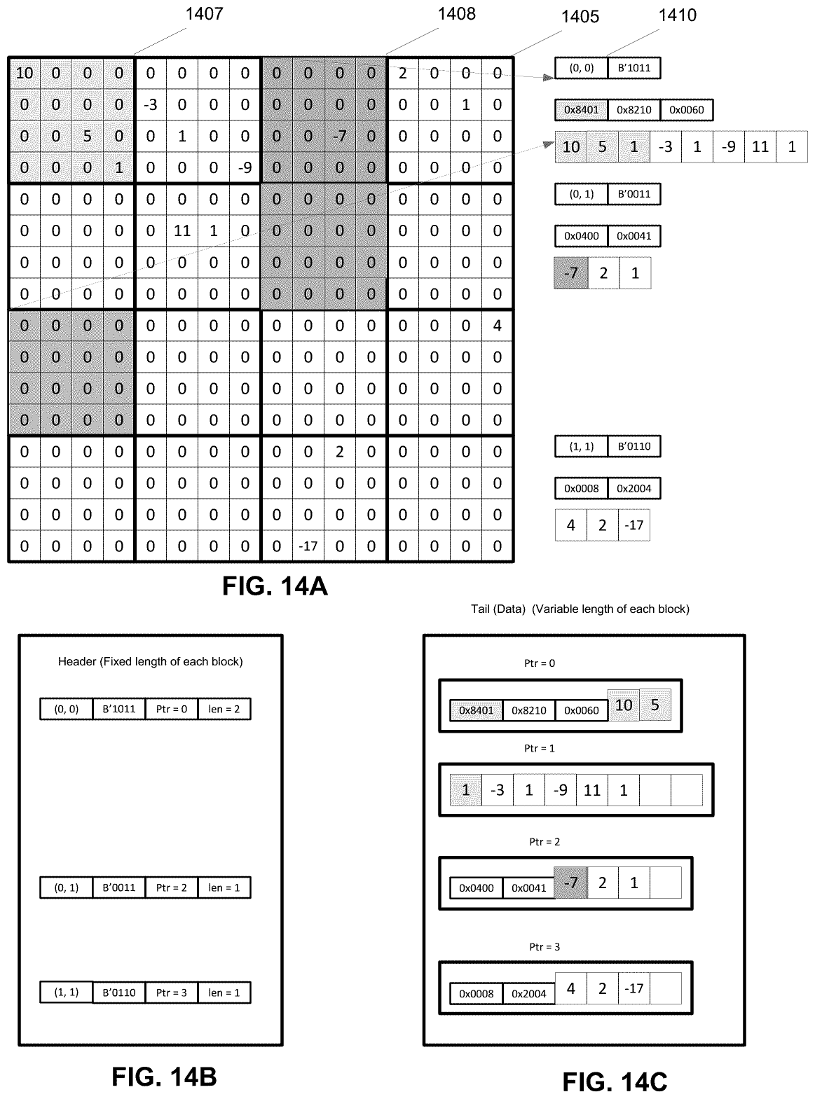

FIGS. 14A-14C is an illustration of an exemplary Head and Tail Compression, in accordance with an embodiment of the present invention.

FIG. 14A shows a packed 8×8 sub-blocks of block or chunk 1405. Indices (0,0) indicates the (row, col) of each 8×8 sub-blocks of block 1405. The indices (0,0) mean the top-left 8×8 sub-blocks 1407. The indices (0,1) mean the top-right 8×8 sub-blocks 1408. The indices (1,1) mean the bottom-right 8×8 sub-block. A 4-bits B′1011 are masks of 4, 4×4 sub-blocks. The top-left sub-block has the least significant bit. The bottom-right 4×4 sub-block is the highest significant bit of these 4 bits. The pointers may link to a location of compressed records of tail (or data). Each compressed record is 8 Bytes. After the pointer is a length. The length is the number of compressed records that will be used for the current 8×8 sub-block.

FIG. 14B shows the head having 4 information including, not a limitation, indices (row, column) of the 8×8 sub-block of chunk 1405. Four (4) bitmasks may indicate four (4) non-zero 4×4 sub-blocks, pointer links to compressed data, and length to indicate how many records of 8 bytes of compressed data. The head may be stored into a hardware memory that may easily extract the information in one or more software instruction cycles.

FIG. 14C shows the tail (data) part, where the masks are packed for each element in four (4) non-zero 4×4 sub-blocks, and the non-zero values. Masks are chopped in 8 bytes. For example, not a limitation, in a hardware memory storage, masks may be stored in a bank alignment format. The data may be chopped into the bank alignment format. Here, an example of 8 bytes bank alignment format is shown. In the first block, are first level masks and packed values whose data may be placed into the bank alignment format. Assuming an 8 bytes bank alignment format, the first block may need more than 8 bytes, which may be chopped into two (2) 8 bytes. Then leave some empty cells in the second 8 bytes. For the second block, less than 8 bytes may be needed, but still use 8 bytes and leave some cells empty. Then the third block is empty. The fourth block also needs less than 8 bytes but 8 bytes aligned. For each 8×8 sub-blocks packed into one or two of records of 8 bytes, if a few bytes are left in the 8×8 sub-blocks, the 8×8 sub-blocks is left empty or filled with zeros (or other predetermined value). Doing so may be easier for hardware to handle the packing and unpacking of data.

In addition to packing of 8×8 sub-blocks, different sizes may be packed including, not a limitation, 4×4 blocks, 16×16 blocks, 8×16 blocks, etc. Data compression is not limited into 8 bytes of record. Different size records may be compressed. In the above example, each element is a byte in 4×4 blocks. A vector like, not a limitation, (R, G, B), (deltaR, deltaG, deltaB) or a vector for point cloud, voxel, or event-based camera may be compressed.

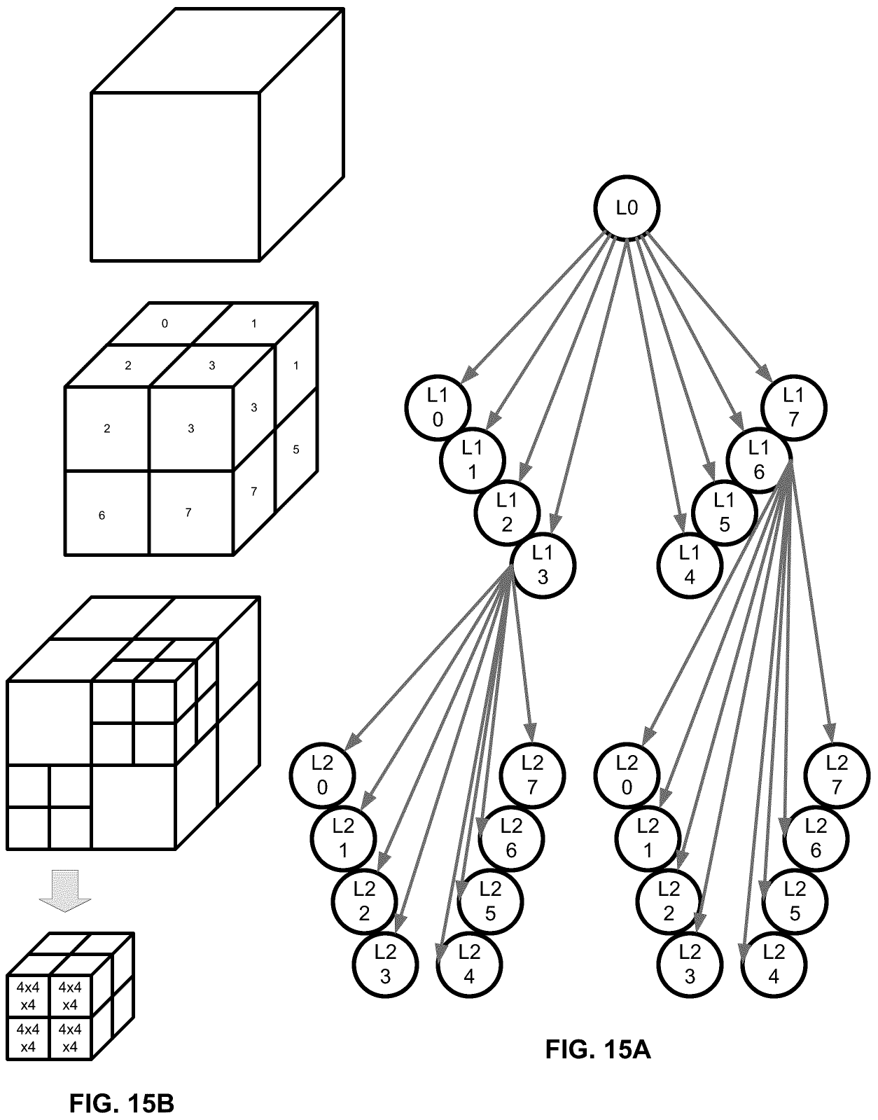

FIG. 15A is an illustration of an exemplary Octree Structure, in accordance with an embodiment of the present invention. An octree is a tree data structure in which each internal node may have eight child nodes. Octrees may be used to partition a three-dimensional space by recursively subdividing it into eight octants. FIG. 15A shows three levels of octrees. In a first level (L0), the granularity may include, not a limitation, 16×16×16 pixels. If there is/are pixel(s) in the 16×16×16 in the first level (L0), the first level (L0) may be further divided into 8×8×8 pixels in a second level (L1). Then, if there are 8×8×8 pixels in the second level (L1), the second level (L1) may be further divided into 4×4×4 pixels in a third level (L2) octree. The example shows that L1(3) and L1(6) octrees has been divided into 4×4×4 pixels. All other spaces are empty.

The above scheme may be combined with indices (e.g. Row, Col) and mask-based compression as shown in FIG. 15B. That is, the indices may indicate the granularity of 16×16×16 pixels/blocks, then octree may divide the 16×16×16 pixels/blocks to the granularity of 4×4×4 pixels/blocks. The mask-based compression may then compress the 4×4×4 pixel/block granularity. Different methods may be combined in order to make the system more efficient.

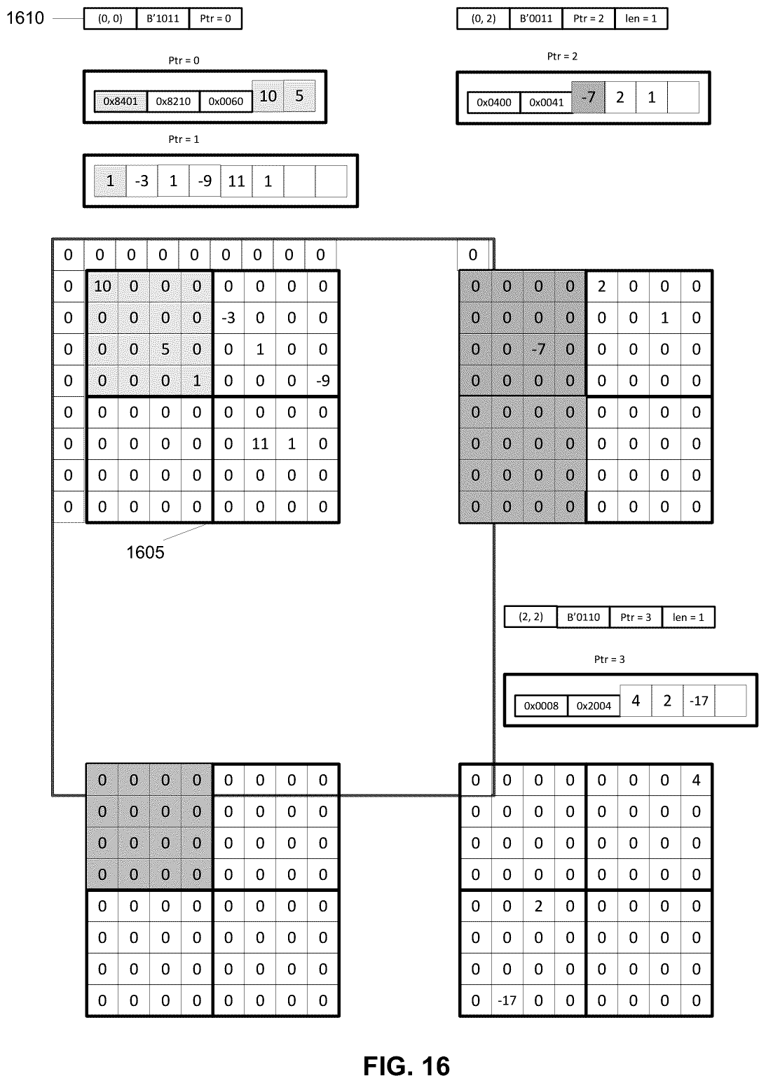

FIG. 16 is an illustration of an exemplary block and neighboring blocks convolution, in accordance with an embodiment of the present invention. A convolution operation may require the current pixel and neighboring pixels. Padding is a term relevant to convolutional neural networks as it refers to the number of pixels added to an image. To do a convolution on a block of images, neighboring blocks may be taken into account. FIG. 16 shows an example of a convolution with a 3×3 kernel and a padding by 1. When the first 8×8 block 1605 is processed, header of the first block is fetched utilizing indices (0, 0) 1610. Then the subblock masks, pointer, and length of data is determined. The compressed data may also be fetched. After the first block is decoded, the neighboring blocks may be considered. In the marked red rectangle, the second block with indices (0,1) and fourth block with indices (1,1) may be fetched. Fetching of the third block with indices (1,0) may be skipped because the third block is all zeros. The third block's indices, nor any information of the header and data may not be saved or stored in memory. If indices (1,0) are not found, the block may contain all zeros. After the second and fourth blocks' header and data are determined, the current block and neighboring blocks may be decoded, as shown on the figure with four 8×8 blocks. a convolution of the current block may then be performed. The method is not limited to decoding the 8×8 blocks and performing a convolution on the current 8×8 block. Different block sizes may be decoded and convolution performed on any block.

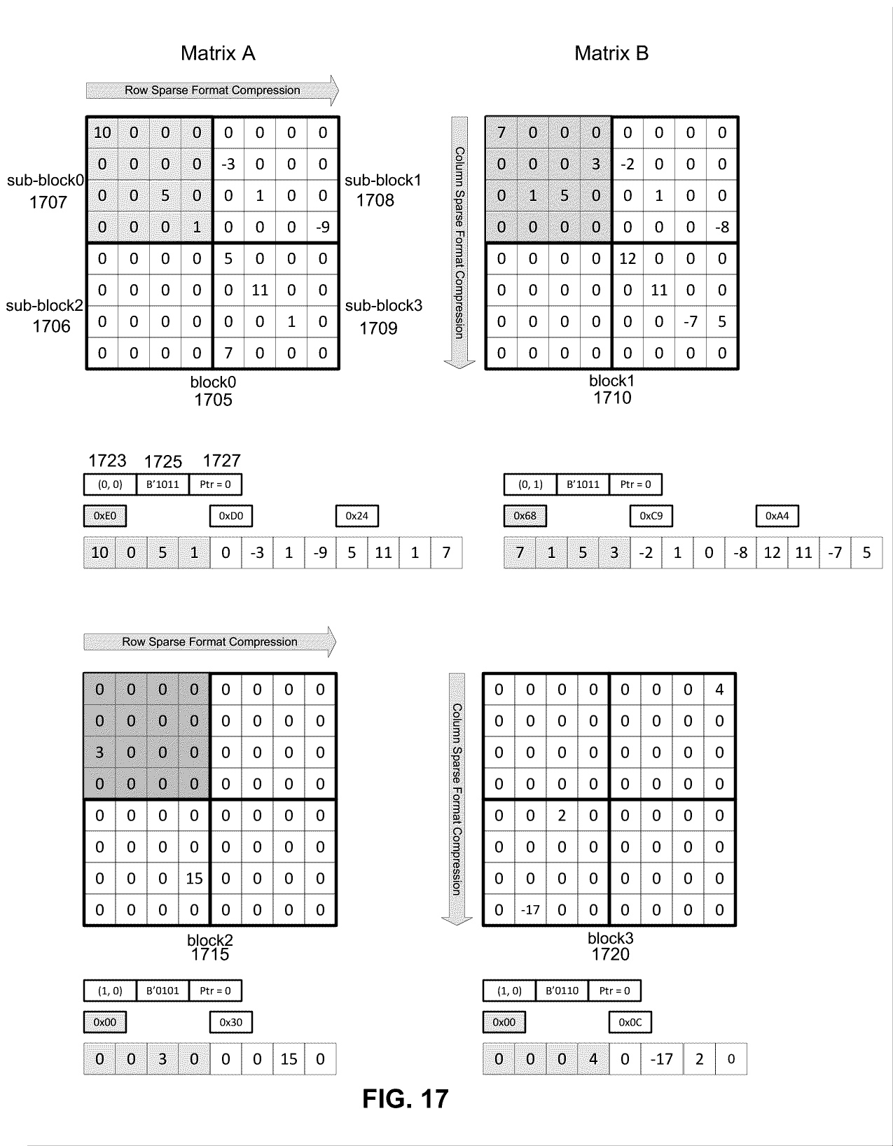

FIG. 17 is an illustration of an exemplary Ratio Sparsity Formats and Blocks, in accordance with an embodiment of the present invention.

For certain applications, lower power is important especially for an Edge device with battery. Some pruning may be done on these types of devices to increase efficiency. There may be a few ways to do pruning including, not a limitation, structural pruning and un-structural pruning. Structural pruning is based on a whole channel pruning or other regular block pruning may have a better fitting into hardware accelerators. However, the accuracy of structural pruned models may drop. For un-structural pruning, weights may be pruned near to zero. When sparsity is un-structural, it may be hard to speed up due to worst case scenarios in hardware. Hardware needs to wait the worst-case scenario when the hardware needs to sync up for parallel computing.

In one embodiment of the present invention, a structural ratio pruning for weights, which is also applicable for feature maps is provided. For weights, a ratio may be kept. For example, not a limitation, a quarter (¼) of weights are non-zero, and three quarters (¾) of weights are zero. Computing may be reduced and compressed easily. Referring to FIG. 17, an 8x8 block0 1705 (on the left) shows each row of 4×4 sized sub-blocks containing at least one non-zero element. Row Sparse Format compression may be applied. On the top left, block0 1705 is divided into four (4) 4×4 subblocks, namely subblock0-subblock4 (1706-1709). Block0 1705 is one of four (4) 8×8 blocks 1705-1720 with indices (0, 0) 1723 to indicate a top left block. In block0 1705, the four subblocks may be represented with index (0, 1, 2, 3) to indicate at least four (4) subblocks. Four (4) bit masks may be used to represent non-zero subblocks. ′B1011 indicates only one subblock (e.g. subblock2 1706) is all zero. To compress the subblocks, indices are needed to indicate the column position of the saved elements. About a quarter (¼) percent of elements may be saved. For instance, not a limitation, the elements (10, 0, 5, 1) in sub-block0 1707 may be saved. The indices of the position may be determined. The position is using the column indices (0, 1, 2, 3). For value (10, 0, 5, 1), an associated column index is (2′b00, 2′bxx, 2′b10, 2′b11). The 2′bxx represents a don't care status. The don't care may be packed and eliminated. To simplify the logic, 2′b00 may be assigned to the don't care with corresponding index of (2′b00, 2′b00, 2′b10, 2′b11). Then represented as 8 bits. The value may be 8′b11100000, and/or 0xE0. Sub-block1 1708 indices may be 8′b11010000=0xD0. Sub-block3 1709 indices may be 8′b00100100=0x24. In sub-block1 1708, another direction of compression called Column Sparse Format Compression was performed. In each row, only one non-zero element in each column of sub-block1 is present. For block1 1710, sub-block0 indices are 8′b01101000=0x68. Similarly, sub-block1's indices are 8′b11001001=0xC9. Sub-block3's indices are 8′b10100100=0xA4. The data of block2 1715 and block3 1720 may be compressed using the same method. The formats above may be packed together similar to the Head Tail compression shown in FIGS. 14A-14C. This is the power of using the hierarchical block, sub-block compression.

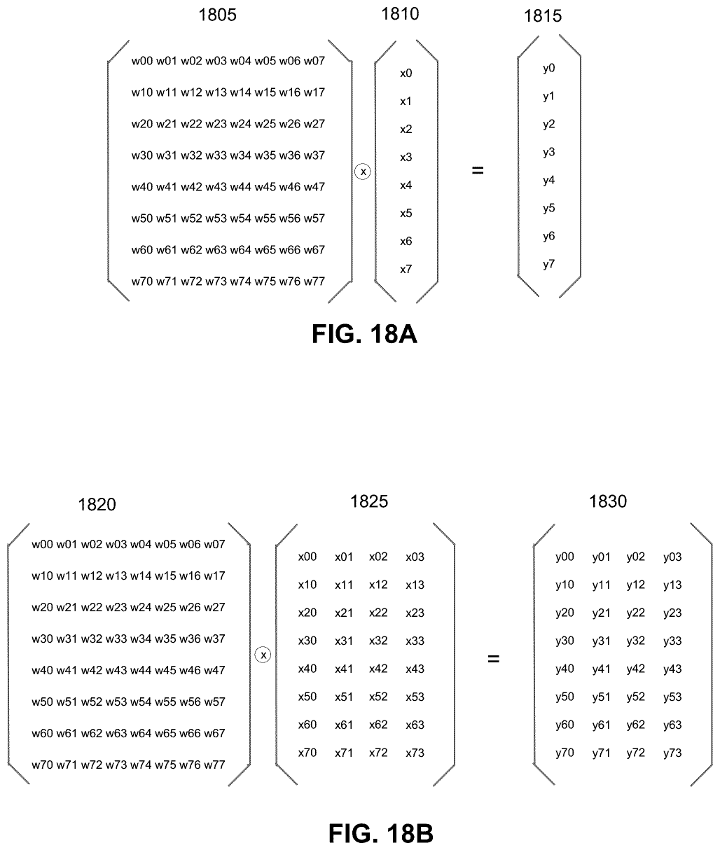

FIG. 18A is an illustration of an exemplary matrix and vector multiplication and FIG. 18B is an illustration of an exemplary a matrix and matrix multiplication, in accordance with an embodiment of the present invention. FIG. 18A shows a matrix and vector multiplication, where a multiplication of a first weight matrix 1805 and a vector 1810 provides the result of a y-vector 1815 as follows:
y0=w00*x0+w01*x1+w02*x2+w03*x3+w04*x4+w05*x5+w06*x6+w07*x7
y1=w10*x0+w11*x1+w12*x2+w13*x3+w14*x4+w15*x5+w16*x6+w17*x7
y2=w20*x0+w21*x1+w22*x2+w23*x3+w24*x4+w25*x5+w26*x6+w02*x7
y7=w70*x0+w71*x1+w72*x2+w73*x3+w74*x4+w75*x5+w76*x6+w77*x7

FIG. 18B shows a multiplication of a second weight matrix 1820 and a feature x-matrix 1825 to get the result of feature y-matrix 1830 as follows:
y00=w00*x00+w01*x10+w02*x20+w03*x30+w04*x40+w05*x50+w06*x60+w07*x70
y01=w00*x01+w01*x11+w02*x21+w03*x31+w04*x41+w05*x51+w06*x61+w07*x71
y02=w00*x02+w01*x12+w02*x22+w03*x32+w04*x42+w05*x52+w06*x62+w07*x72
y03=w00*x03+w01*x13+w02*x23+w03*x33+w04*x43+w05*x53+w06*x63+w07*x73
y70=w70*x00+w71*x10+w72*x20+w73*x30+w74*x40+w75*x50+w76*x60+w77*x70
y71=w70*x01+w71*x11+w72*x21+w73*x31+w74*x41+w75*x51+w76*x61+w77*x71
y72=w70*x02+w71*x12+w72*x22+w73*x32+w74*x42+w75*x52+w76*x62+w77*x72
y73=w70*x03+w71*x13+w72*x23+w73*x33+w74*x43+w75*x53+w76*x63+w77*x73

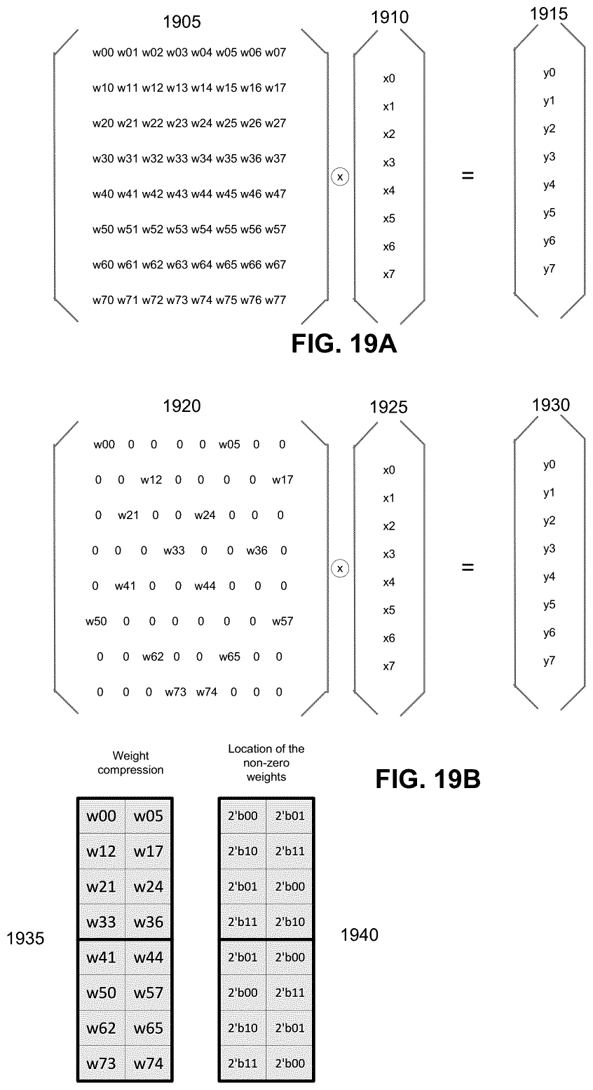

FIGS. 19A and 19B illustrate an exemplary ratio sparsity matrix and vector multiplication, in accordance with an embodiment of the present invention. In one embodiment of the present invention, a multiplication of original weight matrix 1905 and a vector 1910 provides the result of a y-vector 1915 shown in FIG. 19A. Similarly, a multiplication of a pruned weight matrix 1920 and a vector 1925 provides the result of a y-vector 1930 as show in FIG. 19B. The ratio is determined by the sparsity ratio and accuracy of the model. Normally, for a trained neural network model, the deployment of the model, may require a retraining of the model to make a ratio of sparsity on the kernel weight. A special pruning process may make it more energy saving for the deployment. If the ratio is around four (4), roughly 75% of original weights matrix 1905 may be pruned as shown in weight matrix 1920. After original weight matrix 1905 are pruned, pruned weights 1920 may be compressed to nearly ¼ of original weights 1905. Non-zero values are saved in a first table 1935 and two (2) bits are saved in a second table 1940, to indicate which position the non-zero values are located. The two (2) bits position location may be a little bit of overhead. Finally, the hardware storage space is saved.

In some embodiment of the present invention, a novel Neural Processing Unit (NPU) designed to address the challenges associated with processing complex data streams, such as sparsity, 3D convolution, image processing, event-driven cameras, and LiDAR point clouds, within the realm of artificial intelligence. The NPU is complemented by a sophisticated software flow that enables model pruning and retraining, ensuring optimal performance and adaptability. The invention encompasses both hardware and software innovations, representing a significant advancement in AI processing.

Traditional NPUs have exhibited limitations in handling intricate data streams and real-time perceptual tasks. This invention seeks to overcome these limitations by integrating cutting-edge hardware and software components to process diverse data types efficiently. The invention builds upon prior art in neural network processing and model optimization while introducing novel techniques to address the specific challenges identified.

In other embodiments, the NPU described herein is a hardware component specifically designed to process various types of data streams encountered in AI applications. These include, but are not limited to, sparse data, 3D convolution data, image data, event-driven camera feeds, and LiDAR point clouds. The hardware architecture is engineered to optimize processing power, memory utilization, and energy efficiency for each data type.

Additionally, the invention introduces a software flow that leverages model pruning and retraining techniques. This software component ensures that the NPU remains adaptable and capable of handling evolving AI tasks effectively. Model pruning techniques selectively remove redundant or less critical parameters from trained models, leading to enhanced computational efficiency. Retraining techniques are then applied to fine-tune the pruned models, maintaining accuracy while optimizing resource consumption.

### Advantages:

Data Diversity Handling: The NPU's ability to process diverse data streams, including sparsity, 3D convolution, event-driven camera feeds, and LiDAR point clouds, sets it apart from conventional NPUs.

Real-time Perception: By addressing the challenges of real-time processing of complex data, the NPU enables applications such as autonomous vehicles and robotics to make informed decisions in dynamic environments.

Efficient Resource Utilization: The integration of model pruning and retraining techniques optimizes the NPU's resource consumption, enabling it to execute tasks effectively on limited hardware resources.

Adaptability: The NPU's architecture, coupled with the software flow, ensures adaptability to emerging AI tasks through continuous optimization and retraining.

In a further embodiment, the novel Neural Processing Unit (NPU) and associated software flow described in this invention offer a groundbreaking solution to the challenges of processing diverse and complex data streams within the field of artificial intelligence. By enabling efficient processing, real-time perception, and model adaptation, this invention paves the way for AI applications that were previously unattainable with conventional hardware and software approaches. The proposed NPU and software flow hold immense potential for disrupting various industries reliant on AI technology.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied. Such computers referenced and/or described in this disclosure may be any kind of computer, either general purpose, or some specific purpose computer such as, but not limited to, a workstation, a mainframe, GPU, ASIC, etc. The programs may be written in C, or Java, Brew or any other suitable programming language. The programs may be resident on a storage medium, e.g., magnetic or optical, e.g., without limitation, the computer hard drive, a removable disk or media such as, without limitation, a memory stick or SD media, or other removable medium. The programs may also be run over a network, for example, with a server or other machine sending signals to the local machine, which allows the local machine to carry out the operations described herein.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

In some embodiments, the innovation at hand revolves around a Neural Processing Unit (NPU) that transcends the constraints of conventional processing units. The NPU not only excels in handling diverse data streams and complex formats but does so with a level of flexibility and energy efficiency that has been previously unattainable. Central to this innovation is the introduction of the groundbreaking “ratio pruning” software flow, intricately interwoven with the hardware capabilities of the NPU. This proprietary software methodology involves a meticulous process of kernel weight pruning. It is through this unique pruning technique that the NPU's energy efficiency and computational prowess are greatly elevated.

In other embodiments, the ratio pruning process commences with a detailed analysis of the neural network model's kernel weights. By applying ratios and thresholds to these weights, the process identifies parameters that can be pruned without compromising the model's accuracy. This results in the creation of a compressed representation of the neural network model. This compression and decompression capability not only contributes to a streamlined memory footprint but also ushers in a remarkable reduction in computational overhead. Furthermore, by identifying and eliminating parameters that contribute minimally to the model's overall accuracy, unnecessary calculation operations are circumvented, rendering the NPU's processing incredibly efficient. It's important to highlight that this innovation is not solely limited to individual layers or data formats. The “ratio pruning” software flow, in harmony with the NPU's hardware design, has been ingeniously engineered to seamlessly adapt to various layers, formats, and neural network architectures. This adaptability is a cornerstone of the patent's unique proposition.

As a result of this innovation, the NPU stands as a revolutionary processing unit that redefines energy efficiency and computational agility in the realm of AI. This patent application encapsulates not only the technological breakthrough of the “ratio pruning” technique but also its seamless integration with the NPU's hardware architecture, further affirming its potential to become a transformative force in AI processing.

The sparsity method may apply to neural network input, intermediate layer's feature map and each layer's weight, in the example of pruning, the neuron weights may be pruned.

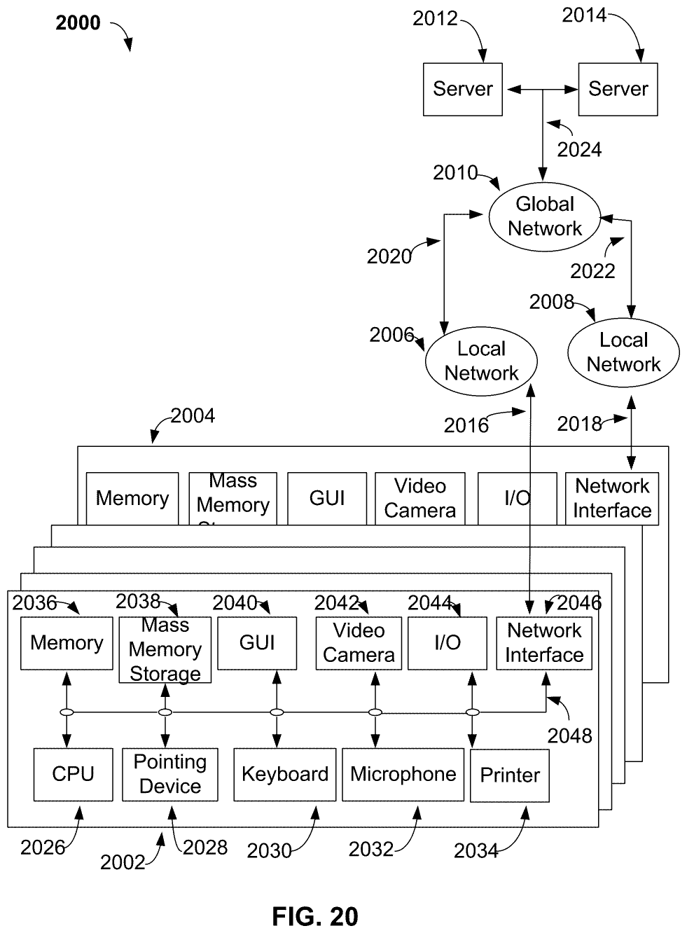

FIG. 20 is a block diagram depicting an exemplary client/server system which may be used by an exemplary web-enabled/networked embodiment of the present invention.

A communication system 2000 includes a multiplicity of clients with a sampling of clients denoted as a client 2002 and a client 2004, a multiplicity of local networks with a sampling of networks denoted as a local network 2006 and a local network 2008, a global network 2010 and a multiplicity of servers with a sampling of servers denoted as a server 2012 and a server 2014.

Client 2002 may communicate bi-directionally with local network 2006 via a communication channel 2016. Client 2004 may communicate bi-directionally with local network 2008 via a communication channel 2018. Local network 2006 may communicate bi-directionally with global network 2010 via a communication channel 2020. Local network 2008 may communicate bi-directionally with global network 2010 via a communication channel 2022. Global network 2010 may communicate bi-directionally with server 2012 and server 2014 via a communication channel 2024. Server 2012 and server 2014 may communicate bi-directionally with each other via communication channel 2024. Furthermore, clients 2002, 2004, local networks 2006, 2008, global network 2010 and servers 2012, 2014 may each communicate bi-directionally with each other.

In one embodiment, global network 2010 may operate as the Internet. It will be understood by those skilled in the art that communication system 2000 may take many different forms. Non-limiting examples of forms for communication system 2000 include local area networks (LANs), wide area networks (WANs), wired telephone networks, wireless networks, or any other network supporting data communication between respective entities.

Clients 2002 and 2004 may take many different forms. Non-limiting examples of clients 2002 and 2004 include personal computers, personal digital assistants (PDAs), cellular phones and smartphones.

Client 2002 includes a CPU 2026, a pointing device 2028, a keyboard 2030, a microphone 2032, a printer 2034, a memory 2036, a mass memory storage 2038, a GUI 2040, a video camera 2042, an input/output interface 2044 and a network interface 2046.

CPU 2026, pointing device 2028, keyboard 2030, microphone 2032, printer 2034, memory 2036, mass memory storage 2038, GUI 2040, video camera 2042, input/output interface 2044 and network interface 2046 may communicate in a unidirectional manner or a bi-directional manner with each other via a communication channel 2048. Communication channel 2048 may be configured as a single communication channel or a multiplicity of communication channels.

CPU 2026 may be comprised of a single processor or multiple processors. CPU 2026 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general-purpose microprocessors.

As is well known in the art, memory 2036 is used typically to transfer data and instructions to CPU 2026 in a bi-directional manner. Memory 2036, as discussed previously, may include any suitable computer-readable media, intended for data storage, such as those described above excluding any wired or wireless transmissions unless specifically noted. Mass memory storage 2038 may also be coupled bi-directionally to CPU 2026 and provides additional data storage capacity and may include any of the computer-readable media described above. Mass memory storage 2038 may be used to store programs, data and the like and is typically a secondary storage medium such as a hard disk. It will be appreciated that the information retained within mass memory storage 2038, may, in appropriate cases, be incorporated in standard fashion as part of memory 2036 as virtual memory.

CPU 2026 may be coupled to GUI 2040. GUI 2040 enables a user to view the operation of computer operating system and software. CPU 2026 may be coupled to pointing device 2028. Non-limiting examples of pointing device 2028 include computer mouse, trackball and touchpad. Pointing device 2028 enables a user with the capability to maneuver a computer cursor about the viewing area of GUI 2040 and select areas or features in the viewing area of GUI 2040. CPU 2026 may be coupled to keyboard 2030. Keyboard 2030 enables a user with the capability to input alphanumeric textual information to CPU 2026. CPU 2026 may be coupled to microphone 2032. Microphone 2032 enables audio produced by a user to be recorded, processed and communicated by CPU 2026. CPU 2026 may be connected to printer 2034. Printer 2034 enables a user with the capability to print information to a sheet of paper. CPU 2026 may be connected to video camera 2042. Video camera 2042 enables video produced or captured by user to be recorded, processed and communicated by CPU 2026.

CPU 2026 may also be coupled to input/output interface 2044 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 2026 optionally may be coupled to network interface 2046 which enables communication with an external device such as a database or a computer or telecommunications or internet network using an external connection shown generally as communication channel 2016, which may be implemented as a hardwired or wireless communications link using suitable conventional technologies. With such a connection, CPU 2026 might receive information from the network, or might output information to a network in the course of performing the method steps described in the teachings of the present invention.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claim's construction of the following claim limitations that are construed under 35 USC § 112 (6)/(f) it is intended that the corresponding means for and/or steps for carrying out the claimed function are the ones that are locally implemented within the jurisdiction of the USA, while the remaining aspect(s) performed or located remotely outside the USA are not intended to be construed under 35 USC § 112 (6) pre-AIA or 35 USC § 112 (f) post AIA. In some embodiments, the methods and/or system components which may be located and/or performed remotely include, without limitation:

It is noted that according to USA law, all claims must be set forth as a coherent, cooperating set of limitations that work in functional combination to achieve a useful result as a whole. Accordingly, for any claim having functional limitations interpreted under 35 USC § 112 (6)/(f) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC § 112 (6)/(f) is/(are) dependent on one or more remote servers located outside the USA, it is intended that each such recited function under 35 USC § 112 (6)/(f) is to be interpreted as the function of the local system receiving the remotely generated information required by a locally implemented claim limitation, wherein the structures and or steps which enable, and breath life into the expression of such functions claimed under 35 USC § 112 (6)/(f) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present patent application, and “35 USC § 112 (6)/(f)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” or “steps for” claim limitation implies that the broadest initial search on 35 USC § 112(6) (post AIA 112(f)) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112(6) (post AIA 112(f) when such corresponding structures are not explicitly disclosed in the foregoing patent specification. Therefore, for any invention element(s)/structure(s) corresponding to functional claim limitation(s), in the below claims interpreted under 35 USC § 112(6) (post AIA 112(f), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claim's construction proceedings and/or examination of patent allowability properly identify and incorporate only the portions of each of these documents discovered during the broadest interpretation search of 35 USC § 112(6) (post AIA 112(f) limitation, which exist in at least one of the patents and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112(6) (post AIA 112(f)), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing sparsity compression for point cloud and voxel according to the present invention will be apparent to those skilled in the art. Various aspects of the invention have been described above by way of illustration, and the specific embodiments disclosed are not intended to limit the invention to the particular forms disclosed. The particular implementation of the sparsity compression for point cloud and voxel may vary depending upon the particular context or application. By way of example, and not limitation, the sparsity compression for point cloud and voxel described in the foregoing were principally directed to sparse block compression implementations; however, similar techniques may instead be applied to memory and energy conservation, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

Only those claims which employ the words “means for” or “steps for” are to be interpreted under 35 USC 112, sixth paragraph (pre-AIA) or 35 USC 112(f) post-AIA. Otherwise, no limitations from the specification are to be read into any claims, unless those limitations are expressly included in the claims.

What is claimed is:

1. A method comprising:
executing a program of computer instructions stored in a non-transitory program storage device, with at least one of an NPU, a CPU, a GPU and a DSP, to perform the steps of:
receiving an input data, said input data representing at least one of a point cloud data, a voxel data, an event-based pixels data, a point cloud data image, a voxel data image, an event-based pixels data image, a neural network's feature map and weights;
configuring said input data into a block of data;
dividing said data block into data sub-block(s);
recording non-zero value(s) of said data sub-block(s);
forming a first bit mask block;
dividing said first bit mask block into sub-block(s) mask(s);
converting sub-block mask(s) with at least one non-zero valued cell into a packed or compressed data;
forming a second bit mask block based on said sub-block mask(s);
converting said second bit mask block mask a packed or compressed data;
assigning indices or location indicators to said packed or compressed data;
storing said packed or compressed data in a first memory address space; and
storing said indices or location indicators in a second memory address space.

2. The method of claim 1, further comprising the steps of:
determining a ratio with a sparsity ratio and said input data, wherein said input data comprises a neural network model;
wherein each data layer having different ratio of pruning including feature map or weights;
wherein the operation is convolution or matrix multiplication;
arranging said neural network model into one or more neural network data sub-block(s); and
pruning each neural network data sub-block(s) with said determined ratio.

3. The method of claim 2, further comprising the steps of:
compressing said neural network data sub-block(s);
assigning indices corresponding to a location of said compressed neural network data sub-block(s);
storing said compressed data and corresponding indices; and
wherein said compressed data and corresponding indices represents said input data.

4. The method of claim 1, further comprising the steps of applying one or more selectors to one or more multiplexers to receive said input data, wherein said block data comprises a neural network data block representing at least one of said point cloud data, voxel data and/or event-based data.

5. The method of claim 1, further comprising the steps of:
converting each cell of said data block into ones (1) and zeros (0) where a non-zero valued cell of said data block corresponds to one (1) and a zero valued cell of said data block corresponds to zero (0), to form said first bit mask block; and
replacing said second bit mask block with a CSR compression format.

6. The method of claim 1 further comprising the steps of:
compressing the data of smaller block sizes or subblock sizes of denser areas;
indicating a location of each compressed block of bigger block sizes with sparse indices (Row, Col) in a sparser area;
representing a small granularity of indices (Row, Col) with an octree; and
wherein for point cloud and/or event camera, pixels are non-evenly distributed.

7. The method of claim 1, wherein a (Depth, Row, Col) of 3D blocks are configured to provide a location of at least one of a point cloud, voxels and event-driven based cameras.

8. The method of claim 1, wherein said bit masking is replaced by a CSR compression format.

9. The method of claim 1, wherein if a sub-block contains all zero cells, indices (Row, Col) and associated data of the packed sub-block are not stored in memory.

10. The method of claim 1 further comprising:
extracting a current block and neighboring blocks; and
performing a convolution operation to said current block and neighboring blocks.

11. The method of claim 10 further comprising skipping said convolution operation step when said current block and neighboring blocks are all zeros.

12. The method of claim 6, further comprising applying said sparse indices and sub-block masking method to an image consisting of a Video image, X-Ray image, MRI image, Radar image, LiDAR image, ToF image, Event based camera image and a sensor image.

13. The method of claim 1 further comprising:
pruning weights to a ratio; and
storing non-zero value(s) and location(s) of the pruned weights;
wherein, each layer of a neural network having different pruning ratios or different compression format.

14. The method of claim 1, further comprising:
fetching said packed or compressed data and corresponding indices or location indicators located in memory;
assigning said fetched indices or location indicators to the packed or compressed data;
unpacking or uncompressing said second bit mask block;
forming a second bit mask block;
unpacking or uncompressing said first bit mask block, wherein a value of “1” corresponds to non-zero sub-blocks;
unpacking said non-zero sub-block according to said second bit mask, wherein a value of “1” is stored in non-zero locations in corresponding locations of the second bit mask, and zero values in the sub-block are set to a “0” in the corresponding locations of said second bit mask;
unpacking non-zero sub-block(s) according to the first bit mask where there is a value of “1” in the first bit mask and storing zero values into the sub-block(s) where there is a “0” in the first bit mask; and,
communicating the uncompressed block to said executing unit for executing.

15. The method of claim 1, wherein:
said step of recording non-zero value(s) of said data sub-block(s) comprises:
arranging said data sub-block(s) into data block(s), each data block having at least two dimensions, wherein said data block(s) includes a multiplicity of data sub-block(s); and
recording non-zero values in said data sub-block(s) in accordance with a first recording pattern.

16. The method of claim 15, in which said first recording pattern comprises:
recording non-zero values of the second dimensionality (2D) or third dimensionality (3D) data sub-blocks in starting from the first row and the first column and sequencing up to a certain predetermined position in the first row and column, and continue to record non-zero values of the subsequent data sub-blocks dimensions according to said first pattern.

17. A non-transitory program storage device storing computer instructions executable with at least one of an NPU, a CPU, a GPU and a DSP to perform a method comprising the steps of:
receiving an input data, said input data comprises at least one of a point cloud data, a voxel data, an event-based pixels data, a point cloud data image, a voxel data image, and an event-based pixels data image;
configuring said input data into a multiple arrayed data block;
configuring said multiple arrayed data block into a plurality of data sub-blocks;
recording non-zero values of said data sub-blocks;
arranging said data block into a first bit mask block;
dividing said first bit mask block into sub-block mask(s);
packing or compressing sub-block masks with non-zero cell contents, wherein sub-block masks with all-zero cell contents are not packed;
assigning indices or location indicators to said packed sub-block masks; and
storing said packed sub-block masks and corresponding indices or location indicators.

18. A software program product stored in a non-transitory program storage device, storing computer instructions executable with at least one of an NPU, a CPU, a GPU and a DSP to perform a method comprising the steps of:
receiving input data representing a data type;
configuring the input data into a data block;
dividing said data block into data sub-blocks having a suitable format and size;
arranging said data sub-blocks into data blocks, each data block having at least two dimensions;
recording non-zero values in each of said data block(s), irrespective of data block or sub-block size or format, and skipping data sub-block(s) containing all zeros;
converting cells of the data block into binary values, wherein a value of ‘1’ is written into corresponding non-zero cells, and a value of ‘0’ is written into corresponding zero-valued cells;
forming a first bit mask block based on said converted data block;
packing or compressing said first bit mask block;
forming a second bit mask block based on said first bit mask block;
packing or compressing said second bit mask block;
assigning indices or location indicators to said packed or compressed data; and
storing said packed or compressed data and corresponding indices or location indicators into memory.

19. The software program product of claim 18, further comprising computer instructions executable to perform a method comprising the steps of:
fetching said packed or compressed data and corresponding indices or location indicators located in memory;
assigning said fetched indices or location indicators to the packed or compressed data;
unpacking or uncompressing said second bit mask block;
forming a second bit mask block;
unpacking or uncompressing said first bit mask block, wherein a value of “1” corresponds to non-zero sub-blocks;
unpacking said non-zero sub-block according to said second bit mask, wherein a value of “1” is stored in non-zero locations in corresponding locations of the second bit mask, and zero values in the sub-block are set to a “0” in the corresponding locations of said second bit mask;
unpacking non-zero sub-block(s) according to the first bit mask where there is a value of “1” in the first bit mask and storing zero values into the sub-block(s) where there is a “0” in the first bit mask; and,
communicating the uncompressed block to said executing unit for executing.

20. The software program product of claim 19, wherein said computer instructions for forming a second bit mask block comprises instructions executable to perform the steps of:
assigning a one (1) to each 4×4 data sub-block having at least one cell containing a non-zero value;
assigning a zero (0) to each 4×4 data sub-block containing all-zero; and
wherein said assigning steps start with a top left 4×4 data sub-block in a first row and first column going to a next column and up to a fourth 4×4 data sub-block in the first row, then continuing to a 4×4 data sub-block of a second row and first column up to a 4×4 data sub-block of a fourth column, then continuing to a 4×4 data sub-block of a third row and first column up to a 4×4 data sub-block of a fourth column, then continuing to a 4×4 data sub-block of a fourth row and first column up to a 4×4 data sub-block of a fourth column.
